(19) United States
(12) Patent Application Publication
(10) Pub. No.: US 2022/0175209 A1
(43) Pub. Date: Jun. 9, 2022

(54) AUTONOMOUS TRAVEL-TYPE CLEANER, METHOD FOR CONTROLLING AUTONOMOUS TRAVEL-TYPE CLEANER, AND PROGRAM

(71) Applicant: PANASONIC INTELLECTUAL PROPERTY MANAGEMENT CO., LTD., Osaka (JP)

(72) Inventors: Hiroyuki MOTOYAMA, Osaka (JP); Yuko TSUSAKA, Kyoto (JP)

(21) Appl. No.: 17/430,544

(22) PCT Filed: Jul. 30, 2020
(86) PCT No.: PCT/JP2020/029261

§ 371 Date: Aug. 12, 2021

(30) Foreign Application Priority Data
Aug. 21, 2019 (JP) 2019-151592

(51) Int. Cl. A47L 11/40; A47L 11/24

(52) U.S. Cl. CPC A47L 11/4011; A47L 2201/06; A47L 2201/04; A47L 11/24

(57) ABSTRACT

Autonomous travel-type cleaner includes a main body, cleaning unit that performs operations of wiping and sweeping of a cleaning target area and sucking of dust, and driver that enables the main body to travel. Autonomous travel-type cleaner further includes person appearance region information acquisition unit that acquires information indicating a person appearance region in which an appearance rate of a person is higher than a threshold in the cleaning target area and controller that controls cleaning unit and driver to cause autonomous travel-type cleaner to clean the person appearance region in the cleaning target area based on current position information acquisition unit that acquires information on a current position of the main body.

### TECHNICAL FIELD

The present disclosure relates to an autonomous travel-type cleaner that autonomously travels in a predetermined space to perform cleaning work, a method for controlling the autonomous travel-type cleaner, and a program.

### BACKGROUND ART

Conventionally, there is known an autonomous travel-type cleaner (hereinafter, also referred to as a “robot cleaner”) that performs the cleaning work while autonomously moving in a limited space (hereinafter, referred to as a “cleaning target area”) inside a building or outdoors (for example, see PTL 1). The autonomous travel-type cleaner produces a movement route from a current position of the autonomous travel-type cleaner to a specific destination to autonomously move along the movement route based on a previously-stored environmental map (also simply referred to as a “map”). Such an autonomous travel-type cleaner is required to efficiently perform the cleaning work.

The robot cleaner disclosed in PTL 1 collects information (hereinafter, “characteristic information about a predetermined region”) about a characteristic of a predetermined region in the cleaning target area using a plurality of sensors mounted on the robot cleaner. PTL 1 discloses a method for classifying the predetermined region to control the movement route of the robot cleaner based on collected information.

However, in the above conventional technique, it is necessary for a robot cleaner to collect the characteristic information about the predetermined region while moving in the cleaning target area. For this reason, it takes time to produce the movement route. Furthermore, it is difficult to efficiently clean the cleaning target area in a limited time.

### CITATION LIST

### Patent Literature

PTL 1: Japanese Patent No. 4597165

### SUMMARY OF THE INVENTION

The present disclosure provides an autonomous travel-type cleaner capable of efficiently cleaning the cleaning target area, a method for controlling the autonomous travel-type cleaner, and a program.

An autonomous travel-type cleaner according to one aspect of the present disclosure is an autonomous travel-type cleaner that autonomously travels in a cleaning target area to clean the cleaning target area. The autonomous travel-type cleaner includes a main body, a cleaning unit that is disposed in the main body to perform at least one operation of wiping or sweeping of the cleaning target area and sucking the dust, and a driver that is disposed in the main body to enable the main body to travel. The autonomous travel-type cleaner includes a person appearance region information acquisition unit that acquires the information indicating at least one person appearance region where the appearance rate of the person is higher than the threshold in the cleaning target area and a current position information acquisition unit that acquires the information indicating the current position of the main body. The autonomous travel-type cleaner further includes a controller that controls at least one of a cleaning unit and a driver to cause the autonomous travel-type cleaner to clean at least one person appearance region in the cleaning target area based on the information indicating at least one person appearance region and the information indicating the current position of the main body.

A control method according to one aspect of the present disclosure is a method for controlling an autonomous travel-type cleaner that autonomously travels in a cleaning target area to clean the cleaning target area. The autonomous travel-type cleaner includes a cleaning unit that is disposed in a main body to perform at least one operation of wiping or sweeping of the cleaning target area and sucking the dust, and a driver that is disposed in the main body to enable the main body to travel. In the method for controlling the autonomous travel-type cleaner, the information on at least one person appearance region where the appearance rate of the person is higher than the threshold in the cleaning target area is acquired, and the current position information about the main body is acquired. In the method for controlling the autonomous travel-type cleaner, a cleaning unit and a driver are controlled to cause the autonomous travel-type cleaner to clean at least one person appearance region in the cleaning target area based on the information indicating at least one person appearance region and the information indicating the current position of the main body.

One aspect of the present disclosure can be implemented as a program causing a computer to perform the method for controlling the autonomous travel-type cleaner. Alternatively, a computer readable non-transitory recording medium storing a program can be implemented.

According to the present disclosure, the cleaning target area can efficiently be cleaned.

### BRIEF DESCRIPTION OF DRAWINGS

FIG. 1 is a view illustrating an outline of an autonomous travel-type cleaner according to a first exemplary embodiment.

FIG. 2 is a perspective view illustrating an appearance of the autonomous travel-type cleaner as viewed from a side direction.

FIG. 3 is a perspective view illustrating the appearance of the autonomous travel-type cleaner as viewed from a front direction.

FIG. 4 is a bottom view illustrating the appearance of the autonomous travel-type cleaner.

FIG. 5 is a block diagram illustrating a functional configuration of the autonomous travel-type cleaner.

FIG. 6 is a view illustrating map information and person appearance region information of the autonomous travel-type cleaner.

FIG. 7 is a view illustrating an example of the person appearance region information of the autonomous travel-type cleaner.

FIG. 8 is a view illustrating an example of cleaning strength of the autonomous travel-type cleaner.

FIG. 9 is a view illustrating an example of cleaning executed based on the cleaning strength in FIG. 8.

FIG. 10 is a flowchart illustrating a first example of an operation of the autonomous travel-type cleaner.

FIG. 11 is a flowchart illustrating a second example of the operation of the autonomous travel-type cleaner.

FIG. 12 is a flowchart illustrating a third example of the operation of the autonomous travel-type cleaner.

FIG. 13 is a block diagram illustrating a functional configuration of an autonomous travel-type cleaner according to a second exemplary embodiment.

FIG. 14 is a view illustrating an example of a cleaning history database of the autonomous travel-type cleaner.

FIG. 15 is a flowchart illustrating an example of an operation of the autonomous travel-type cleaner.

FIG. 16 is a block diagram illustrating a functional configuration of an autonomous travel-type cleaner according to a third exemplary embodiment.

FIG. 17 is a view illustrating an example of the person appearance region information about the autonomous travel-type cleaner.

FIG. 18 is a view illustrating an example of the cleaning strength of the autonomous travel-type cleaner.

FIG. 19 is a flowchart illustrating an example of the operation of the autonomous travel-type cleaner.

FIG. 20 is a view illustrating an example of a cleaning history database in another exemplary embodiment.

### DESCRIPTION OF EMBODIMENTS

First, knowledge underlying the present disclosure and an outline of the present disclosure will be described.

(Knowledge Underlying the Present Disclosure)

Conventionally, when a robot cleaner travels randomly in moving autonomously to perform cleaning, cleaning time becomes long, and there is a risk that the dust is left uncleaned. For this reason, in recent years, a travel route of the robot cleaner is set to improve cleaning efficiency.

For example, the robot cleaner described in PTL 1 proposes a technique of classifying a region in the cleaning target area according to a distance from the robot cleaner to an obstacle, a characteristic of the floor surface, and a degree of dust contamination of the floor surface, and performing control by assigning a cleaning priority. This discloses a configuration in which the floor surface can be cleaned well while a cleaning completion time of the cleaning target area is shortened.

However, in the method described in PTL 1, it is necessary to use a plurality of parameters (the distance to the obstacle, the floor surface characteristic, and the degree of dust contamination) in order to classify the area in the cleaning target area. For this reason, it is difficult to easily and efficiently specify a region that is easily dirty and easily visible. In addition, for example, when the control is performed to more preferentially clean the region classified according to the characteristic of the floor surface than other regions, there is a possibility that only the floor surface where dirt is easily noticeable is cleaned. For this reason, it is difficult to properly and efficiently clean the entire floor surface. Furthermore, a plurality of sensors is required to acquire information about a plurality of parameters. For this reason, sometimes a processing amount of analysis of data acquired from these sensors increases.

The inventors of the present disclosure have focused on the fact that an area through which persons often pass and an area in which many persons exist (stay) are an area in which the dirt is more likely to be accumulated and an area that is conspicuous. In view of the above, the inventors of the present disclosure have found an autonomous travel-type cleaner and a method for control ling the autonomous travel-type cleaner capable of setting cleaning strength of each person appearance region according to an appearance rate of a person while a region where the appearance rate of the person (for example, a number of persons detected per unit area) is higher than a predetermined value is set to the person appearance region, and an outline of the present disclosure is indicated below. Thus, it has been found that a place where the dirt is likely to accumulate can efficiently and appropriately be cleaned.

(Outline of the Present Disclosure)

One aspect of the present disclosure is an autonomous travel-type cleaner that autonomously travels in a cleaning target area to clean the cleaning target area. The autonomous travel-type cleaner includes a cleaning unit that is disposed in a main body to perform at least one operation of wiping or sweeping of the cleaning target area and sucking the dust and a driver that is disposed in the main body to enable the main body to travel. The autonomous travel-type cleaner includes a person appearance region information acquisition unit that acquires the information indicating at least one person appearance region where the appearance rate of the person is higher than the threshold in the cleaning target area and a current position information acquisition unit that acquires the information indicating the current position of the main body. The autonomous travel-type cleaner further includes a controller that controls at least one of a cleaning unit and a driver to cause the autonomous travel-type cleaner to clean at least one person appearance region in the cleaning target area based on the information indicating at least one person appearance region and the information indicating the current position of the main body.

According to this configuration, the controller changes the control contents of the cleaning unit and the driver so as to be different from the area other than the current person appearance region with respect to the person appearance region based on information (hereinafter, referred to as “person appearance region information”) indicating the person appearance region and information (hereinafter, referred to as “current position information”) indicating the current position of the main body. The controller controls the cleaning unit and the driver based on the person appearance region information and the current position information about the main body. Thus, the autonomous travel-type cleaner can efficiently and appropriately clean the cleaning target area that is the person appearance region.

The autonomous travel-type cleaner of one aspect of the present disclosure further includes a setting unit that sets cleaning strength that is cleaning strength of at least one person appearance region based on the appearance rate of the person. The controller may be configured to control at least one of the cleaning unit and the driver based on the cleaning strength of at least one person appearance region set by the setting unit, the information indicating the current position of the main body, and the information indicating at least one person appearance region.

According to this configuration, the controller changes the control contents of the cleaning unit and the driver according to the height of the appearance rate of the person with respect to the person appearance region based on the cleaning strength of the person appearance region set by the setting unit, the current position information about the main body, and the person appearance region information. That is, for example, the region where many persons exist tends to be more easily contaminated, and the contamination tends to be more noticeable. For this reason, the setting unit sets the cleaning strength higher in the region where the appearance rate of the person is higher. Then, the controller controls the cleaning unit and the driver such that the cleaning strength differs from each other in the person appearance region according to the height of the appearance rate of the person. Thus, the autonomous travel-type cleaner can efficiently and appropriately clean the cleaning target area according to the height of the appearance rate of the person with respect to the person appearance region.

The autonomous travel-type cleaner of one aspect of the present disclosure may be configured such that the cleaning strength is represented by at least one of the drive strength of the cleaning unit, drive strength of the driver, a travel pattern of the main body, a cleaning time, and a cleaning frequency.

According to this configuration, the setting unit sets at least one of strength of the operations of wiping or sweeping the cleaning target area and sucking the dust, the running speed of the main body, the travel pattern of the main body, the cleaning time, and the cleaning frequency according to the height of the appearance rate of the person with respect to the person appearance region. That is, the controller appropriately changes the control contents of the cleaner and the driver according to the cleaning strength set by the setting unit. Consequently, the autonomous travel-type cleaner can efficiently clean the cleaning target area while the cleaning method, the cleaning time, the cleaning frequency, and the like are changed for each person appearance region according to the cleaning strength.

In the autonomous travel-type cleaner of one aspect of the present disclosure, the controller may be configured to control at least one of the cleaning unit and the driver according to the cleaning strength of the person appearance region overlapping the main body when determining that the main body overlaps any one of at least one person appearance region.

According to this configuration, when determining that the main body is located in the person appearance region, the controller appropriately changes the control contents of the cleaning unit and the driver according to the cleaning strength of the person appearance region. Thus, when entering the person appearance region, the autonomous travel-type cleaner can efficiently clean the cleaning target area by performing the cleaning according to the cleaning strength of the person appearance region.

In the autonomous travel-type cleaner one aspect of the present disclosure, when determining that the main body overlaps any one of at least one person appearance region, the controller may be configured to control the driver such that the main body reciprocates in the person appearance region, namely, at least between one end of the person appearance region and the other end opposite to the one end.

According to this configuration, when the autonomous travel-type cleaner enters the person appearance region, the controller changes the region other than the person appearance region and the control content of the driver, namely, the travel pattern. Thus, in the autonomous travel-type cleaner, for example, while the main body reciprocates between one pair of ends opposite to each other in the person appearance region, the person appearance region can be cleaned from one end to the other end of the other pair of ends. At this point, the autonomous travel-type cleaner may clean the person appearance region in the travel pattern, and then clean the person appearance region from one end to the other end of one set of ends while reciprocating in the person appearance region between ends of the other set. Consequently, the cleaning strength of the person appearance region is increased. As a result, the cleaning target area can efficiently be cleaned by changing the travel pattern of the main body of the autonomous travel-type cleaner.

The autonomous travel-type cleaner of one aspect of the present disclosure further includes a cleaning history database in which the information indicating at least one person appearance region is associated with the information indicating the cleaning history including the cleaning date and time and the cleaning strength of the at least one person appearance region. The setting unit resets the cleaning strength of at least one person appearance region based on the cleaning history database. The controller may be configured to control at least one of the cleaning unit and the driver based on the cleaning strength reset by the setting unit, the information indicating the current position of the main body, and the information indicating at least one person appearance region.

According to this configuration, the setting unit resets the cleaning strength of the person appearance region set based on the appearance rate of the person in consideration of the cleaning history of the person appearance region. For this reason, the controller can appropriately control the cleaning unit and the driver based on the reset cleaning strength, the current position information about the main body, and the person appearance region information. That is, for example, even when the cleaning strength set based on the appearance rate of the person in the person appearance region is high, the setting unit refers to the cleaning history, and performs the resetting to lower the cleaning strength when the cleaning is performed every day. Consequently, the cleaning target area can be efficiently cleaned in a shorter time compared with the cleaning with the cleaning strength based on the appearance rate of the person.

In the autonomous travel-type cleaner of one aspect of the present disclosure, the controller may be configured to control at least one of the cleaning unit and the driver according to the reset cleaning strength of the person appearance region overlapping the main body when determining that the main body overlaps any one of at least one person appearance region.

According to this configuration, when determining that the main body of the autonomous travel-type cleaner is located in the person appearance region, the controller appropriately changes the control contents of the cleaning unit and the driver according to the cleaning strength of the person appearance region. Thus, when the autonomous travel-type cleaner enters the person appearance region, the cleaning target area can efficiently be cleaned according to the reset cleaning strength of the person appearance region.

In the autonomous travel-type cleaner according to one aspect of the present disclosure, the setting unit further derives the cleaning completion time to complete the cleaning of the cleaning target area, and the controller further monitors the progress of the cleaning of the cleaning target area. When determining that the cleaning of the cleaning target area is not completed within the cleaning completion time, the controller causes the setting unit to change the cleaning strength for at least one person appearance region in the uncleaned area in the cleaning target area. Furthermore, the controller may be configured to control at least one of the cleaning unit and the driver based on the changed cleaning strength, the information indicating the current position of the main body, and the information indicating at least one person appearance region.

According to this configuration, when determining that the cleaning of the cleaning target area is not completed within the cleaning completion time, the controller gives the setting unit an instruction to change the cleaning strength of the person appearance region in the uncleaned area such that the cleaning is completed within the cleaning completion time. The controller appropriately controls the cleaning unit and the driver based on the changed cleaning strength, the current position information about the main body, and the person appearance region information. Thus, the autonomous travel-type cleaner can efficiently clean the cleaning target area within the cleaning completion time.

In the autonomous travel-type cleaner according to one aspect of the present disclosure, when the cleaning completion time of the cleaning target area is set, the setting unit determines whether the cleaning of the cleaning target area is completed within the cleaning completion time based on the information indicating the cleaning completion time. At this point, when determining that the cleaning of the cleaning target area is not completed within the cleaning completion time, the setting unit resets the cleaning strength so as to lower the cleaning strength of at least one person appearance region. The controller may be configured to control at least one of the cleaning unit and the driver based on the cleaning strength reset by the setting unit, the information indicating the current position of the main body, and the information indicating at least one person appearance region.

According to this configuration, when the user of the autonomous travel-type cleaner sets the cleaning completion time, the setting unit resets the cleaning strength so as to complete the cleaning within the cleaning completion time and so as to lower the cleaning strength of the person appearance region. For this reason, the controller can appropriately control the cleaning unit and the driver based on the reset cleaning strength, the current position information about the main body, and the person appearance region information. Thus, the autonomous travel-type cleaner can efficiently clean the cleaning target area within the set cleaning completion time.

Further, in the autonomous travel-type cleaner according to one aspect of the present disclosure, the setting unit further sets the travel route on which the cleaner travels in the cleaning target area in order from the person appearance region having the higher cleaning strength in at least one person appearance region. The controller may be configured to control at least one of the cleaning unit and the driver based on the information indicating the travel route set by the setting unit, the information indicating the current position of the main body, and the information indicating at least one person appearance region.

According to this configuration, the setting unit sets the cleaning strength and sets the cleaning route on which the person appearance region is cleaned in descending order of the cleaning strength. Accordingly, for example, it is possible to preferentially and efficiently clean the area that is easily dirty and is easily visible to the person in the person appearance region.

One aspect of the present disclosure is a method for controlling an autonomous travel-type cleaner that autonomously travels in a cleaning target area to clean the cleaning target area. The autonomous travel-type cleaner includes a cleaning unit that is disposed in a main body of the autonomous travel-type cleaner to perform at least one of operations of wiping, sweeping, and sucking the dust in the cleaning target area and the driver that is disposed in the main body to enable the main body to travel. The method for controlling the autonomous travel-type cleaner acquires information about at least one human presence region where the appearance rate of the person is higher than a threshold in the cleaning target area, and acquires current position information about the main body. In the method for controlling the autonomous travel-type cleaner, a cleaning unit and a driver are controlled to cause the autonomous travel-type cleaner to clean at least one person appearance region in the cleaning target area based on the information indicating at least one person appearance region and the information indicating the current position of the main body.

According to this configuration, the controller changes the control contents of the cleaning unit and the driver so as to be different from the area other than the current person appearance region with respect to the person appearance region based on information (hereinafter, referred to as “person appearance region information”) indicating the person appearance region and information (hereinafter, referred to as “current position information”) indicating the current position of the main body. The controller appropriately controls the cleaning unit and the driver based on the person appearance region information and the current position information about the main body. Thus, the autonomous travel-type cleaner can be caused to appropriately clean the person appearance region. As a result, the autonomous travel-type cleaner can efficiently clean the cleaning target area.

These comprehensive or specific modes may be implemented by a system, a method, an integrated circuit, a computer program, or a computer-readable recording medium such as a CD-ROM. These comprehensive or specific modes may be implemented by any combination of a system, a method, an integrated circuit, a computer program, and a recording medium.

Hereinafter, exemplary embodiments will specifically be described with reference to the drawings.

The following exemplary embodiments provide a comprehensive, specific example of the present disclosure. For this reason, numerical values, shapes, materials, components, arrangement positions and connection modes of the components, steps, and order of the steps, for example, illustrated in the exemplary embodiments are examples, and therefore are not intended to limit the present disclosure. Those components introduced in the following exemplary embodiments that are not recited in the independent claim(s) representing the most superordinate concept are illustrated herein as optional components.

Each drawing is not necessarily strictly illustrated. In each drawing, the same component as that in another drawing is designated by the same numeral, and sometimes the description is omitted or simplified.

In the following description, a term indicating a relationship between elements such as parallel and perpendicular, a term indicating a shape of an element such as a cylindrical shape, and a numerical range do not represent only a strict meaning, but include a substantially equivalent range, for example, measuring an amount of a detection target substance (for example, a number or a concentration) or a range of the detection target substance.

### First Exemplary Embodiment

Hereinafter, an autonomous travel-type cleaner according to a first exemplary embodiment will be specifically described in terms of items with reference to the drawings.

[Outline]

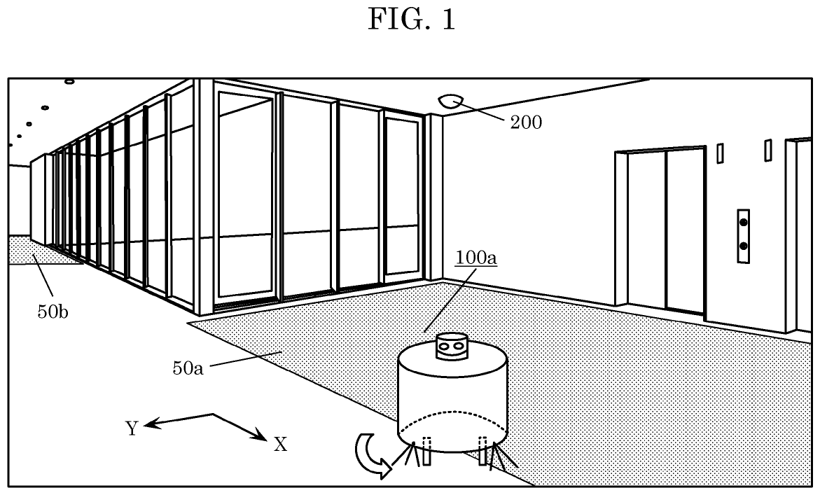

An outline of autonomous travel-type cleaner 100a of the first exemplary embodiment will be described with reference to FIG. 1.

FIG. 1 is a view illustrating the outline of autonomous travel-type cleaner 100a of the first exemplary embodiment.

FIG. 1 illustrates autonomous travel-type cleaner 100a that autonomously travels in a cleaning target area (in this case, an inside of a building) and cleans person appearance region 50a. Person appearance region 50a is a region where an appearance rate of a person is higher than a threshold in the cleaning target area. Specifically, for example, the appearance rate of the person is a total value obtained by counting a number of persons detected by sensor 200 installed in the cleaning target area for a predetermined period. Autonomous travel-type cleaner 100a may acquire the person appearance region information derived from sensing data of sensor 200 by an external device (not illustrated). Details will be described later.

In addition, the person appearance region is a region where there are many persons and movement of the person is likely to occur. Therefore, the floor surface is more easily soiled in the person appearance region than in the region where there are few persons and movement of the person is hardly generated.

Examples of the area where the movement of the person is easily generated include an area where passages such as T-shaped roads and cross-roads cross each other (for example, person appearance region 50b in FIG. 1), an area where a doorway such as a door and an automatic door exists, and an area where a moving device such as an elevator, stairs, and an escalator is installed. For example, in FIG. 1, the person enters the building from the outside through the automatic door on the minus side of the X-axis of person appearance region 50a. For this reason, a vicinity of the automatic door easily becomes dirty because the dirt is brought from the outside into the building. In addition, because the elevator is installed on the minus side of the Y-axis of person appearance region 50a, movement of the person is easily generated through the elevator. For this reason, person appearance region 50a including the automatic door and the elevator becomes an area where the dirt is easily brought along with the movement of the person.

The region where the movement of the person is easily generated may be previously determined by the user, or may be automatically determined from the shape of the map of the cleaning target area by the external device. Furthermore, the region where the movement of the person is easily generated may be determined by measuring a number of times in which the person passes through the predetermined region with a sensor such as a camera or a distance sensor.

That is, in the first exemplary embodiment, for example, the region in which the appearance rate of the person is higher than a predetermined value, such as person appearance region 50a and person appearance region 50b in FIG. 1, is identified as a region that easily gets dirty (in which the dirt is easily accumulated). Autonomous travel-type cleaner 100a cleans person appearance region 50a and person appearance region 50b where the appearance rate of the person is high with the control content different from the control content in the region other than the person appearance region. Thus, autonomous travel-type cleaner 100a can efficiently clean the cleaning target area.

[Configuration]

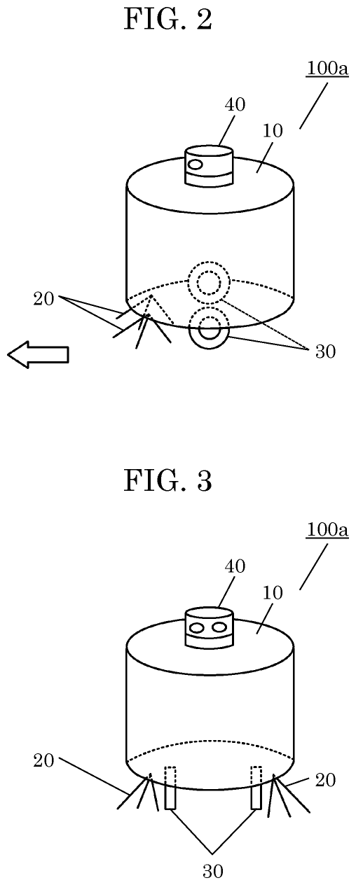

A specific configuration of autonomous travel-type cleaner 100a will be described below with reference to FIGS. 2 to 5.

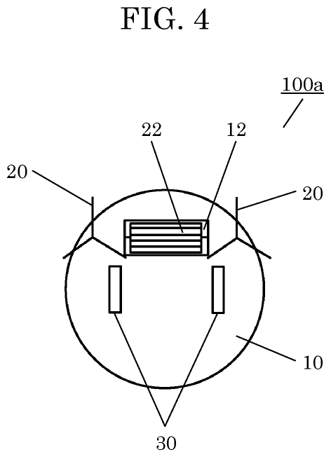

FIG. 2 is a perspective view illustrating an appearance of autonomous travel-type cleaner 100a of the first exemplary embodiment as viewed from a side direction. FIG. 3 is a perspective view illustrating the appearance of autonomous travel-type cleaner 100a as viewed from a front direction. FIG. 4 is a bottom view illustrating the appearance of autonomous travel-type cleaner 100a.

As illustrated in FIGS. 2 and 3, autonomous travel-type cleaner 100a of the first exemplary embodiment includes main body 10, two side brushes 20, main brush 22, two wheels 30, and laser range finder 40.

As illustrated in FIG. 4, main body 10 includes suction port 12 formed to open at a bottom. Suction port 12 sucks dust and the like existing on a floor surface of the cleaning target area into main body 10.

Although not illustrated, main body 10 accommodates a drive motor that drives two side brushes 20 and main brush 22, a suction motor that sucks dust, a power transmission unit that transmits power to the motor, a dust accommodation unit that accommodates the sucked dust, a plurality of sensors including laser range finder 40, a control unit, and the like.

In the first exemplary embodiment, main body 10 has a substantially cylindrical shape (including a cylindrical shape) in a top view, but is not limited thereto. The shape of main body 10 can appropriately be changed according to design.

Side brush 20 sweeps the dust on the floor surface around main body 10, and guides the dust to suction port 12 and main brush 22. In the first exemplary embodiment, autonomous travel-type cleaner 100a includes two side brushes 20. Side brush 20 is disposed on a front side of a bottom surface of main body 10. A rotation direction of side brush 20 is a direction in which the dust can be collected from the front of main body 10 toward suction port 12. A number of side brushes 20 is not limited to two, and may be one or three or more. Furthermore, the number of side brushes may arbitrarily be selected by a user. Each of the side brushes may have a detachable structure.

Main brush 22 is disposed at suction port 12, scrapes up the dust under main body 10, and guides the dust to suction port 12. For example, main brush 22 includes a core (not illustrated) having a rotation center axis and a brush bristle (not illustrated) provided on an outer periphery of the core. The rotating direction of main brush 22 is a direction in which the dust can be scraped up from below to above on the rear side of the rotation center axis.

In the first exemplary embodiment, the configuration in which main body 10 includes suction port 12 is described as an example. However, the main body may not include the suction port. In the first exemplary embodiment, the configuration including two side brushes 20 and main brush 22 has been described as an example. However, the first exemplary embodiment is not limited to the configuration. For example, main body 10 may include a mop that wipes the floor surface. In the mop, a brush may be removably installed. In this case, for example, main body 10 may be configured to include an atomizer (not illustrated) that sprays water to the floor surface. Thus, the floor surface can be wiped with the mop by spraying the water with the atomizer, or can be wiped with only the mop.

Wheel 30 is a wheel that causes autonomous travel-type cleaner 100a to travel. A number of wheels 30 is not limited to two, but may be three or four.

Laser range finder 40 measures a distance between main body 10 and an object existing around main body 10. Laser range finder 40 is exemplified by an infrared sensor including a laser irradiation unit and a laser light receiving unit. For example, laser range finder 40 is disposed on an upper portion of main body 10. At this point, laser range finder 40 may be rotatably attached.

Autonomous travel-type cleaner 100a may include a plurality of sensors in addition to laser range finder 40. For example, the plurality of sensors such as an obstacle detection sensor, a collision detection sensor, a floor detection sensor, a dust sensor, a positioning sensor, or a camera may be included. Specifically, the obstacle detection sensor detects an obstacle existing in front of main body 10. The collision object detection sensor detects that main body 10 collides with a surrounding object. The floor surface detection sensor detects the floor surface. The dust detection sensor detects an amount of dust. The positioning sensor measures position information by a global positioning system (GPS), a global navigation satellite system (GNSS), or the like in order to detect a self position of main body 10. The camera captures an image of a periphery of main body 10.

Autonomous travel-type cleaner 100a of the first exemplary embodiment is configured as described above.

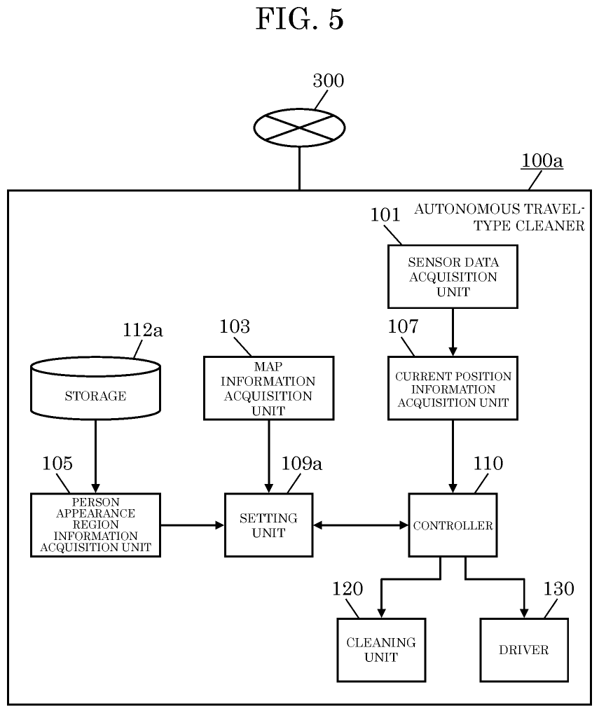

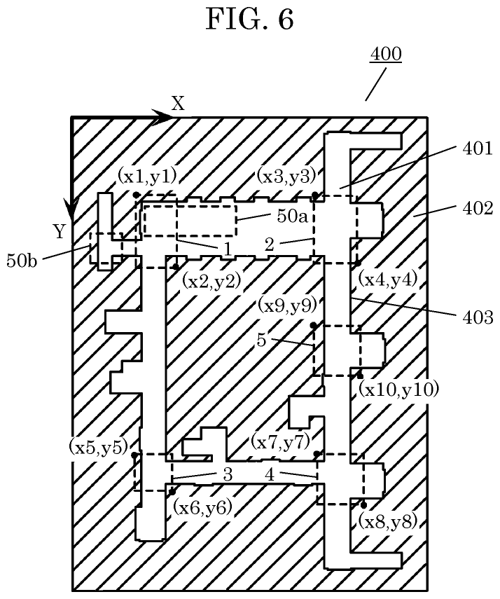

A functional configuration of autonomous travel-type cleaner 100a of the first exemplary embodiment will be described below with reference to FIG. 5.

FIG. 5 is a block diagram illustrating the functional configuration of autonomous travel-type cleaner 100a of the first exemplary embodiment.

As illustrated in FIG. 5, autonomous travel-type cleaner 100a includes sensor data acquisition unit 101, map information acquisition unit 103, person appearance region information acquisition unit 105, current position information acquisition unit 107, setting unit 109a, controller 110, storage 112a, cleaning unit 120, and driver 130 as functional configurations.

Sensor data acquisition unit 101 is connected to various sensors such as laser range finder 40 included in autonomous travel-type cleaner 100a, and periodically acquires sensing data detected by the various sensors. For example, sensor data acquisition unit 101 and the various sensors including laser range finder 40 may be connected by wireless communication such as Bluetooth (registered trademark) or wired communication such as Ethernet (registered trademark).

Current position information acquisition unit 107 calculates the position of autonomous travel-type cleaner 100a in the cleaning target area based on the data acquired by sensor data acquisition unit 101.

Map information acquisition unit 103 acquires map information indicating a map of the cleaning target area. Specifically, for example, map information acquisition unit 103 acquires the map information in which the map of the cleaning target area is produced by a map production technology such as simultaneous localization and mapping (SLAM). Alternatively, map information acquisition unit 103 may acquire the map information input from the external device (not illustrated) through network 300. The map information may be previously stored in storage 112a. In this case, map information acquisition unit 103 reads and acquires the map information from storage 112a.

The map information and person appearance region information 500 generated by map information acquisition unit 103 will be described below with reference to FIG. 6.

FIG. 6 is a view illustrating map information 400 and person appearance region information 500 in the first exemplary embodiment. FIG. 6 illustrates an example in which person appearance region information 500 is input to map information 400.

For example, map information 400 in FIG. 6 may be an image file indicating the map of the cleaning target area. In this case, in map information 400, for example, one grid size is illustrated as 1 cm.

As illustrated in FIG. 6, map information 400 includes information indicating travelable region 401, non-travelable region 402, and boundary 403 of travelable region 401 or non-travelable region 402.

Travelable region 401 is a region where autonomous travel-type cleaner 100a can travel, namely, a region that can be cleaned. For example, travelable region 401 is the floor surface.

Non-travelable region 402 is a region where autonomous travel-type cleaner 100a cannot travel, namely, a region that cannot be cleaned. For example, non-travelable region 402 is a region where a wall, a column, stairs, or the like is located.

Boundary 403 is information indicating the position of the boundary between travelable region 401 and non-travelable region 402. For example, boundary 403 is a place where a wall surface, a glass surface, a door, a door of an elevator, or the like is located.

Map information 400 may be transmitted to an external communication terminal such as a tablet terminal or a computer device, and may be configured to be displayable. In this case, the user may display map information 400 on a display screen of the communication terminal, select a predetermined region of map information 400 using a touch panel, a mouse, or the like, and input an instruction to register the selected region as the person appearance region.

As described above, map information acquisition unit 103 generates the map information and person appearance region information 500.

Hereinafter, the description returns to FIG. 5.

Person appearance region information acquisition unit 105 in FIG. 5 acquires at least one person appearance region information in which the appearance rate of the person is higher than a predetermined threshold in the cleaning target area. For example, person appearance region information acquisition unit 105 acquires person appearance region information 500 derived by the external device (not illustrated). In this case, the external device acquires the sensing data from a security camera installed in the cleaning target area or sensor 200 (see FIG. 1) such as an infrared sensor, and detects the person in the sensing data. A method for detecting the person from the sensing data is not particularly limited, and may be a conventionally known method. For example, when sensor 200 is a camera, the appearance rate of the person may be represented by a number of detected persons in the image at predetermined time intervals, or may be represented by density of detection points in the image. Specifically, the external device first extracts a region where the appearance rate of the person is higher than a predetermined threshold. Then, the external device outputs information including two diagonal coordinates (X, Y) of the region to autonomous travel-type cleaner 100a as person appearance region information 500.

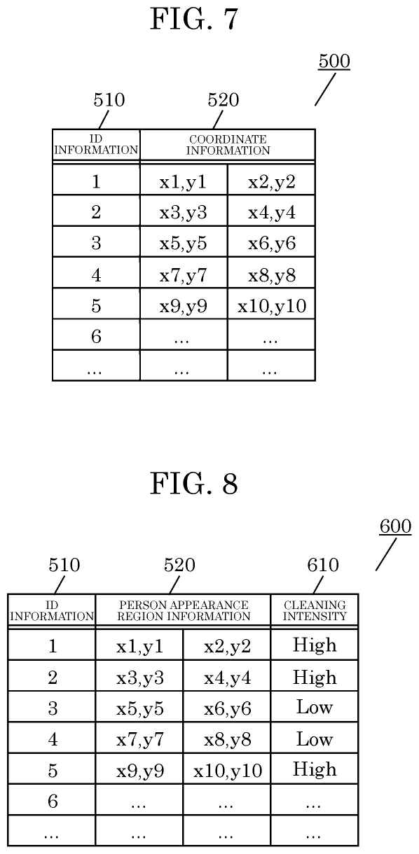

At this point, an example of person appearance region information 500 will be described with reference to FIG. 7.

FIG. 7 is a diagram illustrating the example of person appearance region information 500 in the first exemplary embodiment.

As illustrated in FIG. 7, for example, person appearance region information 500 includes identifier (ID) information 510 and coordinate information 520.

ID information 510 is identification information identifying the person appearance region, and is associated with coordinate information 520 for each person appearance region. In FIG. 7, ID information 510 is indicated by consecutive numbers, but may not be consecutive numbers.

Coordinate information 520 is information indicating the position and size of the person appearance region in the cleaning target area. For example, as illustrated in FIG. 6, two axes (for example, X-axis and Y-axis) orthogonal to each other are previously determined in map information 400. For example, identification information 1 of the person appearance region of ID information 510 includes (x1, y1) and (x2, y2) as coordinate information 520, and has a rectangular region having a pair of diagonal points represented by these two coordinates. As described above, coordinate information 520 includes the coordinates of the pair of diagonal points corresponding to XY axes of map information 400. Thus, the position and size of identification information 1 in the person appearance region of ID information 510 are expressed in map information 400 (that is, the cleaning target area). The same applies to identification information 2 about the person appearance region, identification information 3 about the person appearance region, identification information 4 about the person appearance region, and identification information 5 about the person appearance region in ID information 510 of FIG. 7.

At this time, for example, person appearance region information 500 may provide ID information 510 to each coordinate information 520 after person appearance region information acquisition unit 105 acquires coordinate information 520 about the person appearance region derived by the external device. In addition, the user may provide ID information 510 to the person appearance region information (in this case, coordinate information 520) derived by the external device, and then person appearance region information acquisition unit 105 may acquire person appearance region information 500. At this point, the user may add an arbitrary region as the person appearance region. In this case, first the user causes a display unit (not illustrated) included in a tablet terminal (not illustrated) or an external communication device (not illustrated) to display map information 400. Then, for example, the user designates the arbitrary area with a touch panel or a mouse. Thus, the user adds the coordinate information about the arbitrary area to person appearance region information 500. At this point, the cleaning strength of the added person appearance region may be configured to be settable by the user.

Person appearance region information 500 is configured as described above.

Hereinafter, the description returns to FIG. 5.

Person appearance region information acquisition unit 105 in FIG. 5 reads person appearance region information 500 stored in storage 112a, and outputs person appearance region information 500 to setting unit 109a.

Current position information acquisition unit 107 acquires information indicating a current position of autonomous travel-type cleaner 100a (that is, main body 10) in the cleaning target area. Specifically, current position information acquisition unit 107 derives the self position (that is, the current position) in the cleaning target area by the SLAM based on sensing data obtained from various sensors included in autonomous travel-type cleaner 100a, data obtained from laser range finder 40, map information 400, and the like.

Storage 112a stores sensing data acquired from various sensors by autonomous travel-type cleaner 100a, data from laser range finder 40, person appearance region information 500, map information 400, and the like.

Setting unit 109a sets the cleaning strength that is the strength of the cleaning of the person appearance region based on the appearance rate of the person. Specifically, setting unit 109a sets the cleaning strength of the person appearance region based on the appearance rate of the person.

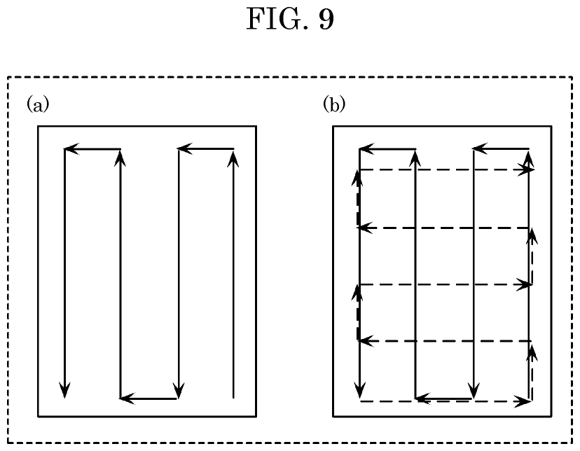

At this point, an example of the above-described cleaning strength will be described with reference to FIG. 8.

FIG. 8 is a view illustrating the example of cleaning strength 610 of the first exemplary embodiment. For example, setting unit 109a may store table 600 in which set cleaning strength 610 is associated with person appearance region information 500 in storage 112a.

As illustrated in FIG. 8, for example, cleaning strength 610 is set such that the person appearance region in which the appearance rate of the person is higher than a first threshold (for example, 60%) is set to High, and the person appearance region lower than or equal to the first threshold is set to Low.

Cleaning strength 610 is not limited to the settings of High and Low, but may set the person appearance region that is greater than 50% and less than or equal to the first threshold (for example, 60%) to five, the person appearance region that is greater than the first threshold and less than or equal to a second threshold (70%) to four, the person appearance region that is greater than the second threshold and less than or equal to a third threshold (for example, 80%) to three, the person appearance region that is greater than the third threshold and less than or equal to a fourth threshold (for example, 90%) to two, and the person appearance region that is greater than the fourth threshold to one. That is, classification and the threshold of cleaning strength 610 may be arbitrarily set according to a situation.

At this point, for example, cleaning strength 610 is represented by at least one of drive strength of cleaning unit 120, drive strength of driver 130, a travel pattern of main body 10, a cleaning time, and a cleaning frequency. For example, the drive strength of cleaning unit 120 is the drive strength of the suction motor or the drive strength of the brush drive motor. The drive strength of driver 130 is drive strength of the drive motor of wheel 30. The control content based on cleaning strength 610 will be described later.

Cleaning strength 610 is set as described above.

Hereinafter, the description returns to FIG. 5.

Setting unit 109a in FIG. 5 derives the cleaning completion time to complete the cleaning of the cleaning target area. Specifically, setting unit 109a sets cleaning strength 610 for person appearance region information 500. Then (for example, after table 600 in FIG. 8 (described later) is produced), the cleaning completion time to complete the cleaning of the cleaning target area is derived.

After setting the derived cleaning completion time of the cleaning target area, setting unit 109a determines whether the cleaning of the cleaning target area is completed within the cleaning completion time based on the information indicating the cleaning completion time. At this point, when determining that the cleaning of the cleaning target area is not completed within the cleaning completion time, setting unit 109a resets cleaning strength 610 so as to lower cleaning strength 610 of the person appearance region.

For example, the cleaning completion time is set by the user. In the first exemplary embodiment, the travel route of autonomous travel-type cleaner 100a is also previously set by the user. At this point, for example, when controller 110 determines that the cleaning is not completed within the cleaning completion time, setting unit 109a may reset the travel route. In this case, for example, setting unit 109a resets the travel route based on person appearance region information 500, the current position information, and map information 400.

For example, based on person appearance region information 500 and the current position information about main body 10, controller 110 in FIG. 5 controls at least one of cleaning unit 120 and driver 130 to cause autonomous travel-type cleaner 100a to clean the person appearance region of the cleaning target area.

That is, when determining that main body 10 overlaps any one of the plurality of person appearance regions, controller 110 controls at least one of cleaning unit 120 and driver 130 according to cleaning strength 610 of the person appearance region overlapping main body 10. Specifically, when determining that main body 10 overlaps any one of the person appearance regions, namely, determining that autonomous travel-type cleaner 100a is located in the person appearance region, controller 110 outputs an instruction to increase the drive strength of the suction rotor to cleaning unit 120. Thus, cleaning unit 120 increases the drive strength of the suction rotor. As a result, autonomous travel-type cleaner 100a travels and performs the cleaning while strongly sucking the floor surface.

In addition, when determining that main body 10 overlaps any of the plurality of person appearance regions, controller 110 controls driver 130 such that main body 10 is reciprocated in the person appearance region, namely, at least between one end of the person appearance region and the other end opposite to the one end.

An example of the cleaning performed based on cleaning strength 610 will be described below with reference to FIG. 9.

FIG. 9 is a diagram illustrating the example of the cleaning performed based on cleaning strength 610 of FIG. 8. Part (a) of FIG. 9 illustrates the example of the cleaning performed when cleaning strength 610 is Low. Part (b) of FIG. 9 illustrates the example of the cleaning performed when cleaning strength 610 is High. An example in which cleaning strength 610 is represented by the drive strength (for example, the drive strength of the suction motor) of cleaning unit 120 and the travel pattern of main body 10 will be described below.

As described above, in autonomous travel-type cleaner 100a of the first exemplary embodiment, the drive strength of the suction motor is increased in the person appearance region as compared with the region other than the person appearance region, and the floor surface is strongly sucked. Furthermore, controller 110 changes the control content of driver 130 according to cleaning strength 610 of the person appearance region. Thus, autonomous travel-type cleaner 100a cleans the person appearance region in the following travel pattern of FIG. 9.

Specifically, as indicated by solid arrows in part (a) of FIG. 9, when cleaning strength 610 of the person appearance region is Low, autonomous travel-type cleaner 100a cleans the person appearance region while reciprocating between a pair of ends (in this case, the lower end and the upper end) opposite to each other in the person appearance region. Autonomous travel-type cleaner 100a cleans the person appearance region from one end (right end) to the other end (left end) of another set of ends (in this case, the right end and the left end) of the person appearance region while reciprocating.

On the other hand, when cleaning strength 610 of the person appearance region is High, as indicated by solid arrows in part (b) of FIG. 9, autonomous travel-type cleaner 100a cleans the person appearance region from the right end toward the left end while reciprocating between the lower end and the upper end of the person appearance region. Then, as indicated by broken arrows in part (b) of FIG. 9, autonomous travel-type cleaner 100a cleans the person appearance region from the lower end toward the upper end while reciprocating between the left end and the right end of the person appearance region.

That is, controller 110 controls at least one of cleaning unit 120 and driver 130 according to cleaning strength 610 of the person appearance region. The control of cleaning unit 120 and driver 130 according to cleaning strength 610 is not limited to the examples in parts (a) and (b) of FIG. 9. For example, controller 110 may control drive strength of driver 130 so as to lower the travelling speed of autonomous travel-type cleaner 100a. Thus, a staying time of autonomous travel-type cleaner 100a in the person appearance region can be increased to increase the cleaning strength of the person appearance region. Furthermore, controller 110 may control the drive strength of cleaning unit 120 to increase the rotation speed of the brush, and increase the cleaning strength of the person appearance region.

As described above, the cleaning is performed based on cleaning strength 610.

Hereinafter, the description returns to FIG. 5.

Controller 110 in FIG. 5 monitors progress of the cleaning of the cleaning target area. When determining that the cleaning of the cleaning target area is not completed within the cleaning completion time, controller 110 causes setting unit 109a to change cleaning strength 610 with respect to at least one person appearance region in the uncleaned area in the cleaning target area. That is, controller 110 controls at least one of cleaning unit 120 and driver 130 based on changed cleaning strength 610, the current position information about main body 10, and person appearance region information 500. Accordingly, the cleaning of the cleaning target area can be completed within the cleaning completion time.

Controller 110 also controls at least one of cleaning unit 120 and driver 130 based on cleaning strength 610 reset by setting unit 109a, the current position information about main body 10, and person appearance region information 500. Specifically, controller 110 controls cleaning unit 120 and driver 130 of autonomous travel-type cleaner 100a according to a cleaning plan set by setting unit 109a. Thus, according to the cleaning plan, autonomous travel-type cleaner 100a cleans each region (the person appearance region and the region other than the person appearance region) of the cleaning target area while travelling along the travel route. The cleaning plan includes the travel route and the cleaning strength of the person appearance region.

Cleaning unit 120 in FIG. 5 is disposed in main body 10 of autonomous travel-type cleaner 100a, and performs at least one operation of wiping, sweeping, and sucking dust in the cleaning target area.

As described with reference to FIGS. 2 to 4, cleaning unit 120 includes two side brushes 20, main brush 22, and suction port 12.

Cleaning unit 120 includes a suction motor (not illustrated) that sucks the dust on the floor surface from suction port 12, a power transmission unit (not illustrated) that transmits power to the suction motor, and a fan (not illustrated). The suction motor is connected to a fan, and rotates the fan to generate suction air.

Cleaning unit 120 also includes a brush drive motor (not illustrated) that rotates two side brushes 20 and main brush 22 that sweep the floor surface to collect the dust, and the power transmission unit (not illustrated) that transmits the power to the brush drive motor. The brush drive motor individually rotates side brush 20 and main brush 22.

Driver 130 in FIG. 5 is disposed on main body 10, and enables main body 10 to travel. Driver 130 includes two wheels 30.

Driver 130 includes a drive motor (not illustrated) that rotates wheels 30 and a power transmission unit (not illustrated) that transmits the power to the drive motor. The drive motor rotationally drives two wheels 30 individually. Thus, autonomous travel-type cleaner 100a can perform operations such as a stationary operation, a rotating operation, a backward operation, and a forward operation. Driver 130 may include an auxiliary wheel (not illustrated) in addition to wheel 30. The auxiliary wheel is a wheel that is not driven by the drive motor.

Autonomous travel-type cleaner 100a is configured as described above.

[Operation]

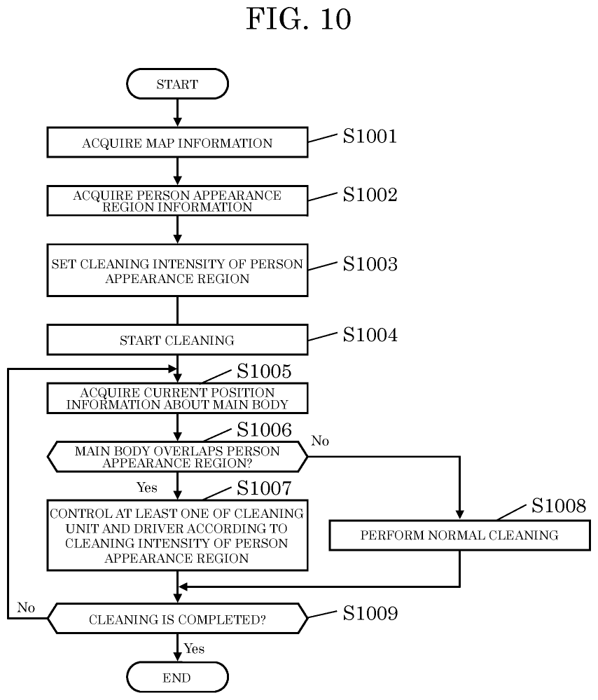

A first example, a second example, and a third example of the operation of autonomous travel-type cleaner 100a will be specifically described below with reference to FIGS. 10 to 12.

### First Example

A first example of the operation of autonomous travel-type cleaner 100a will be described with reference to FIGS. 10 and 5.

FIG. 10 is a flowchart illustrating the first example of the operation of autonomous travel-type cleaner 100a according to the first exemplary embodiment.

As illustrated in FIG. 10, map information acquisition unit 103 acquires map information 400 (see FIG. 6) indicating the map of the cleaning target area (step S1001). At this point, as described above, autonomous travel-type cleaner 100a may acquire map information 400 from the external device (not illustrated) through communication, or may produce map information 400 through the SLAM.

Autonomous travel-type cleaner 100a starts the cleaning from an arbitrary position in map information 400. Hereinafter, for example, as illustrated in FIG. 6, the position of autonomous travel-type cleaner 100a is assumed to be expressed by an (x, y) coordinate expressed by a pixel value or a distance when the upper left of map information 400 is described as an origin of the coordinate. For this reason, autonomous travel-type cleaner 100a starts the cleaning from an arbitrary position set by the user at the start of the cleaning. Autonomous travel-type cleaner 100a sequentially cleans the cleaning target areas from the cleaning start position for each area, and travels the entire cleaning area (travelable region 401 in FIG. 6) to perform the cleaning.

Subsequently, person appearance region information acquisition unit 105 acquires person appearance region information 500 (see FIG. 7) (step S1002). That is, person appearance region information acquisition unit 105 acquires person appearance region information 500 derived by the external device (not illustrated). Person appearance region information 500 may be previously acquired and stored in storage 112a. In this case, person appearance region information acquisition unit 105 reads and acquires person appearance region information 500 from storage 112a.

Subsequently, setting unit 109a sets cleaning strength 610 of the person appearance region (step S1003). Specifically, setting unit 109a sets cleaning strength 610 of the person appearance region based on the appearance rate of the person. Because the example of the setting of cleaning strength 610 has been described above, the description is omitted here. At this point, setting unit 109a may store set cleaning strength 610 in storage 112a as table 600 in FIG. 8 associated with person appearance region information 500.

Subsequently, when setting unit 109a finishes the setting of the cleaning strength of the person appearance region, controller 110 starts the control of driver 130 so as to travel along the previously-set travel route. Thus, autonomous travel-type cleaner 100a starts the cleaning of the cleaning target area (step S1004).

Subsequently, current position information acquisition unit 107 acquires the current position information about autonomous travel-type cleaner 100a in the cleaning target area (step S1005). Specifically, current position information acquisition unit 107 derives the self position (that is, the current position) in the cleaning target area by the SLAM based on the sensing data (hereinafter, also referred to as sensor data) of various sensors acquired by sensor data acquisition unit 101, the data acquired from laser range finder 40, the map information, and the like. Thus, current position information acquisition unit 107 acquires current position information about autonomous travel-type cleaner 100a. At this point, the current position information is periodically derived while autonomous travel-type cleaner 100a is driven.

In the example described in the first exemplary embodiment, autonomous travel-type cleaner 100a travels along the previously-set travel route. However, the present disclosure is not limited to the example. For example, as described above, setting unit 109a causes current position information acquisition unit 107 to periodically acquire the current position information about autonomous travel-type cleaner 100a. Accordingly, when the travel route is changed while autonomous travel-type cleaner 100a is driven, setting unit 109a may adjust the travel route of autonomous travel-type cleaner 100a based on the periodically acquired current position information, map information 400, and person appearance region information 500.

Here, the description returns to FIG. 10.

When the cleaning is started in step S1004, controller 110 determines whether the position of main body 10 overlaps the person appearance region (step S1006). That is, controller 110 determines whether main body 10 is located in the person appearance region. At this point, when determining that main body 10 overlaps the person appearance region (Yes in step S1006), controller 110 controls at least one of cleaning unit 120 and driver 130 according to cleaning strength 610 of the person appearance region overlapping main body 10 (step S1007). Specifically, while main body 10 is located in the person appearance region, controller 110 performs the control to increase the drive strength of the suction motor more than in the region other than the person appearance region. Consequently, the suction rate of the dust and the like on the floor surface is improved because the floor surface can be strongly sucked.

On the other hand, when determining that the position of main body 10 does not overlap the person appearance region (No in step S1006), controller 110 controls autonomous travel-type cleaner 100a to perform normal cleaning (step S1008). Specifically, controller 110 performs the cleaning while maintaining the control of cleaning unit 120 and driver 130 in the area other than the person appearance region. That is, controller 110 does not change the drive strength of the suction motor so as to increase the drive strength.

In the above description, the example in which the drive strength of the suction motor is changed has been described. However, the present disclosure is not limited to the example. For example, as illustrated in FIG. 9, when determining that the position of main body 10 overlaps the person appearance region (Yes in step S1006), controller 110 may control driver 130 to change the travel pattern of autonomous travel-type cleaner 100a. That is, as illustrated in part (a) of FIG. 9, autonomous travel-type cleaner 100a may be caused to run in reversals (reciprocate) in a predetermined direction in the person appearance region. Further, as illustrated in part (b) of FIG. 9, controller 110 may control driver 130 such that autonomous travel-type cleaner 100a runs in reversals in a plurality of directions. In this manner, controller 110 controls at least one of cleaning unit 120 and driver 130. Consequently, controller 110 can perform the control such that autonomous travel-type cleaner 100a performs appropriately the cleaning according to the cleaning strength of the person appearance region.

Subsequently, controller 110 determines whether the cleaning of the cleaning target area is completed (step S1009). At this point, when determining that the cleaning of the cleaning target area is not completed (No in step S1009), controller 110 returns to the processing in step S1005, and similarly performs the following steps. On the other hand, when determining that the cleaning of the cleaning target area is completed (Yes in step S1009), controller 110 moves autonomous travel-type cleaner 100a to a predetermined position (not illustrated) such as a charger, and finishes the cleaning.

### Second Example

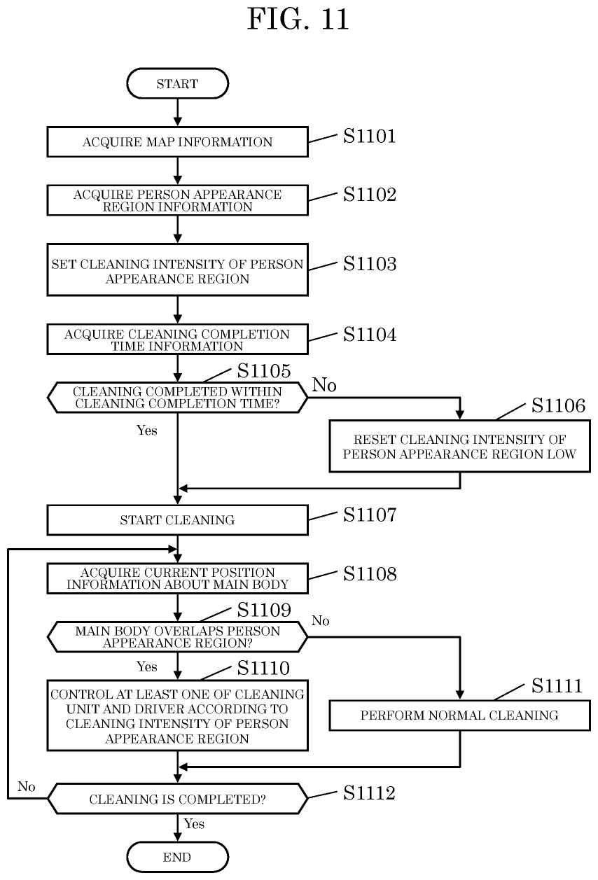

A second example of the operation of autonomous travel-type cleaner 100a will be described below with reference to FIGS. 5 and 11.

FIG. 11 is a flowchart illustrating the second example of the operation of autonomous travel-type cleaner 100a of the first exemplary embodiment. In the second example, the description of the operation overlapping the first example will be omitted or simplified.

As illustrated in FIG. 11, map information acquisition unit 103 acquires map information 400 (see FIG. 6) indicating a map of the cleaning target area (step S1101).

Subsequently, person appearance region information acquisition unit 105 acquires person appearance region information 500 (see FIG. 7) (step S1102).

Subsequently, setting unit 109a sets cleaning strength 610 of the person appearance region (step S1103).

Subsequently, setting unit 109a acquires the cleaning completion time of the cleaning target area (step S1104). Specifically, setting unit 109a acquires the information indicating the cleaning completion time by setting the cleaning completion time by the user.

Subsequently, setting unit 109a determines whether the cleaning of the cleaning target area is completed within the cleaning completion time based on the acquired information indicating the cleaning completion time (step S1105). At this point, when determining that the cleaning of the cleaning target area is not completed within the cleaning completion time (No in step S1105), setting unit 109a resets cleaning strength 610 so as to lower (decrease) cleaning strength 610 in the person appearance region (step S1106).

On the other hand, when setting unit 109a determines that the cleaning of the cleaning target area is completed within the cleaning completion time (Yes in S1105), autonomous travel-type cleaner 100a starts the cleaning (step S1107).

When the cleaning is started, current position information acquisition unit 107 acquires the current position information about autonomous travel-type cleaner 100a in the cleaning target area (step S1108).

Subsequently, controller 110 determines whether main body 10 overlaps the person appearance region (step S1109). At this point, when determining that main body 10 overlaps the person appearance region (Yes in step S1109), controller 110 controls at least one of cleaning unit 120 and driver 130 based on cleaning strength 610 reset by setting unit 109a, the current position information of main body 10, and person appearance region information 500 (step S1110). On the other hand, when determining that main body 10 does not overlap the person appearance region (No in S1109), controller 110 performs the normal cleaning (step S1111). Specifically, controller 110 performs the cleaning while maintaining the control of cleaning unit 120 and driver 130 in the area other than the person appearance region.

Subsequently, controller 110 determines whether the cleaning of the person appearance region is completed (step S1112). At this point, when determining that the cleaning of the cleaning target area is not completed (No in step S1112), controller 110 returns to the processing in step S1108, and similarly performs the following steps. On the other hand, when determining that the cleaning of the cleaning target area is completed (Yes in S1112), controller 110 moves autonomous travel-type cleaner 100a to a predetermined position (not illustrated) such as a charger, and finishes the cleaning.

### Third Example

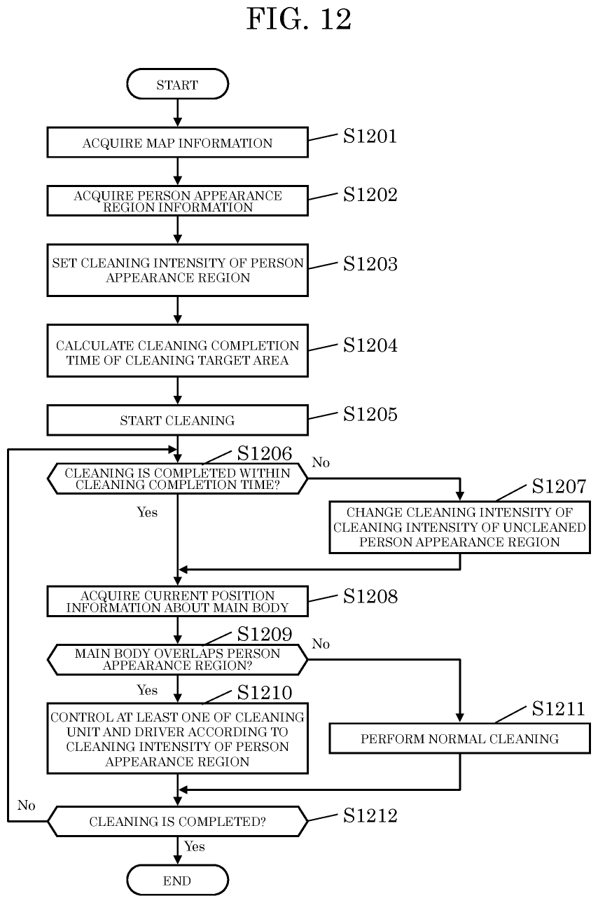

A third example of the operation of autonomous travel-type cleaner 100a will be described below with reference to FIGS. 5 and 12.

FIG. 12 is a flowchart illustrating the third example of the operation of autonomous travel-type cleaner 100a of the first exemplary embodiment. In the following example, the description of the operation overlapping the first and second examples will be omitted or simplified.

As illustrated in FIG. 11, map information acquisition unit 103 acquires map information 400 (see FIG. 6) indicating the map of the cleaning target area (step S1201).

Subsequently, person appearance region information acquisition unit 105 acquires person appearance region information 500 (see FIG. 7) (step S1202).

Subsequently, setting unit 109a sets cleaning strength 610 of the person appearance region (step S1203).

Subsequently, setting unit 109a derives the cleaning completion time to complete the cleaning of the cleaning target area (step S1204).

Autonomous travel-type cleaner 100a starts the cleaning (step S1205).

Subsequently, when the cleaning is started, controller 110 monitors the progress of the cleaning of the cleaning target area to determine whether the cleaning of the cleaning target area is completed within the cleaning completion time (step S1206). At this point, when determining that the cleaning of the cleaning target area is not completed within the cleaning completion time (No in step S1206), controller 110 causes setting unit 109a to change cleaning strength 610 with respect to the person appearance region in the uncleaned area in the cleaning target area (step S1207).

On the other hand, when controller 110 determines that the cleaning of the cleaning target area is completed within the cleaning completion time (Yes in step S1206), or after the performance of step S1207, current position information acquisition unit 107 acquires the current position information about autonomous travel-type cleaner 100a in the cleaning target area (step S1208).

Subsequently, controller 110 determines whether main body 10 overlaps the person appearance region (step S1209). At this point, when determining that the position of main body 10 overlaps the person appearance region (Yes in step S1209), controller 110 controls at least one of cleaning unit 120 and driver 130 based on cleaning strength 610 changed by setting unit 109a, the current position information of main body 10, and person appearance region information 500 (step S1210). Because the control of cleaning unit 120 and driver 130 has been described in the first or second example, the description will be omitted.

On the other hand, when determining that the position of main body 10 does not overlap the person appearance region (No in S1209), controller 110 performs the normal cleaning (step S1211). That is, controller 110 performs the cleaning while maintaining the control of cleaning unit 120 and driver 130 in the area other than the person appearance region.

Subsequently, controller 110 determines whether the cleaning of the cleaning target area is completed (step S1212). At this point, when determining that the cleaning of the cleaning target area is not completed (No in step S1212), controller 110 returns to the processing in step S1206, and similarly performs the following steps. On the other hand, when determining that the cleaning of the cleaning target area is completed (Yes in step S1212), controller 110 moves autonomous travel-type cleaner 100a to a predetermined position (not illustrated) such as a charger, and finishes the cleaning.

[Effects and Others]

As described above, autonomous travel-type cleaner 100a of the first exemplary embodiment can efficiently clean the area where the appearance rate of the person is higher than the threshold and that easily gets dirty (what is called a person appearance region).

That is, autonomous travel-type cleaner 100a of the first exemplary embodiment is autonomous travel-type cleaner 100a that autonomously travels in the cleaning target area to clean the cleaning target area. Autonomous travel-type cleaner 100a includes main body 10, cleaning unit 120 that is disposed in main body 10 to perform at least one operation of wiping or sweeping of the cleaning target area, and sucking the dust, and driver 130 that is disposed in main body 10 to enable main body 10 to travel. Autonomous travel-type cleaner 100a includes person appearance region information acquisition unit 105 that acquires the information indicating at least one person appearance region where the appearance rate of the person is higher than the threshold in the cleaning target area and current position information acquisition unit 107 that acquires the information indicating the current position of main body 10. Autonomous travel-type cleaner 100a further includes controller 110 that controls at least one of cleaning unit 120 and driver 130 to cause the autonomous travel-type cleaner to clean at least one person appearance region in the cleaning target area based on the information indicating at least one person appearance region and the information indicating the current position of main body 10.

According to this configuration, controller 110 changes the control contents of cleaning unit 120 and driver 130 such that the person appearance region is different in control from the region other than the person appearance region based on person appearance region information 500 and the current position information about main body 10. Controller 110 controls cleaning unit 120 and driver 130 based on person appearance region information 500 and the current position information about main body 10. Thus, autonomous travel-type cleaner 100a can efficiently and appropriately clean the cleaning target area that is the person appearance region.

Autonomous travel-type cleaner 100a of the first exemplary embodiment further includes setting unit 109a that sets cleaning strength 610 that is the cleaning strength of at least one person appearance region based on the appearance rate of the person. Controller 110 may be configured to control at least one of cleaning unit 120 and driver 130 based on cleaning strength 610 of at least one person appearance region set by setting unit 109a, the information indicating the current position of main body 10, and the information indicating at least one person appearance region.

According to this configuration, controller 110 changes the control contents of cleaning unit 120 and driver 130 according to the height of the appearance rate of the person with respect to the person appearance region based on cleaning strength 610 of the person appearance region set by setting unit 109a, the current position information about main body 10, and person appearance region information 500. That is, for example, the region where many persons exist tends to be more easily contaminated, and the contamination tends to be more noticeable. For this reason, setting unit 109a sets cleaning strength 610 higher in the region where the appearance rate of the person is higher. Then, controller 110 controls cleaning unit 120 and driver 130 such that cleaning strength 610 differs from each other in the person appearance region according to the height of the appearance rate of the person. Thus, autonomous travel-type cleaner 100a can efficiently and appropriately clean the cleaning target area according to the height of the appearance rate of the person with respect to the person appearance region.

Autonomous travel-type cleaner 100a of the first exemplary embodiment may be configured such that cleaning strength 610 is represented by at least one of the drive strength of cleaning unit 120, the drive strength of driver 130, the travel pattern of main body 10, the cleaning time, and the cleaning frequency.

According to this configuration, for example, setting unit 109a sets at least one of the wiping or sweeping of the cleaning target area, the strength of the operation of sucking the dust, the running speed of main body 10, the travel pattern of main body 10, the cleaning time, and the cleaning frequency according to the height of the appearance rate of the person with respect to the person appearance region. That is, controller 110 appropriately changes the control contents of cleaning unit 120 and driver 130 according to cleaning strength 610 set by setting unit 109a. Consequently, autonomous travel-type cleaner 100a can efficiently clean the cleaning target area while the cleaning method, the cleaning time, the cleaning frequency, and the like are changed for each person appearance region according to cleaning strength 610.

Furthermore, in autonomous travel-type cleaner 100a of the first exemplary embodiment, controller 110 may be configured to control at least one of cleaning unit 120 and driver 130 according to cleaning strength 610 of the person appearance region overlapping main body 10 when determining that main body 10 overlaps any one of at least one person appearance region.

According to this configuration, when determining that main body 10 is located in the person appearance region, controller 110 appropriately changes the control contents of cleaning unit 120 and driver 130 according to cleaning strength 610 of the person appearance region. Thus, when entering the person appearance region, autonomous travel-type cleaner 100a can efficiently clean the cleaning target area by performing the cleaning according to cleaning strength 610 of the person appearance region.

Furthermore, in autonomous travel-type cleaner 100a of the first exemplary embodiment, when determining that main body 10 overlaps any one of at least one person appearance region, controller 110 may be configured to control driver 130 such that main body 10 reciprocates in the person appearance region, namely, at least between one end of the person appearance region and the other end opposite to the one end.

According to this configuration, when autonomous travel-type cleaner 100a enters the person appearance region, controller 110 changes the region other than the person appearance region and the control content of driver 130, namely, the travel pattern. Thus, in autonomous travel-type cleaner 100a, for example, while main body 10 reciprocates between one pair of ends opposite to each other in the person appearance region, the person appearance region can be cleaned from one end to the other end of the other pair of ends. At this point, autonomous travel-type cleaner 100a may clean the person appearance region in the above-described travel pattern, and then clean the person appearance region from one end to the other end of one set of ends while reciprocating in the person appearance region between the other set of ends. Consequently, cleaning strength 610 of the person appearance region is increased. As a result, the cleaning target area can efficiently be cleaned by changing the travel pattern of main body 10 of autonomous travel-type cleaner 100a.

Furthermore, in autonomous travel-type cleaner 100a of the first exemplary embodiment, controller 110 may be configured to control at least one of cleaning unit 120 and driver 130 according to reset cleaning strength 610 of the person appearance region overlapping main body 10 when determining that main body 10 overlaps any one of at least one person appearance region.

According to this configuration, when determining that main body 10 of autonomous travel-type cleaner 100a is located in the person appearance region, controller 110 appropriately changes the control contents of cleaning unit 120 and driver 130 according to cleaning strength 610 of the person appearance region. Thus, when autonomous travel-type cleaner 100a enters the person appearance region, the cleaning target area can efficiently be cleaned according to reset cleaning strength 610 of the person appearance region.

Furthermore, in autonomous travel-type cleaner 100a of the first exemplary embodiment, setting unit 109a further derives the cleaning completion time to complete the cleaning of the cleaning target area, and controller 110 further monitors the progress of the cleaning of the cleaning target area. When determining that the cleaning of the cleaning target area is not completed within the cleaning completion time, controller 110 causes setting unit 109a to change cleaning strength 610 for at least one person appearance region in the uncleaned area in the cleaning target area. Furthermore, controller 110 may be configured to control at least one of cleaning unit 120 and driver 130 based on changed cleaning strength 610, the information indicating the current position of main body 10, and the information indicating at least one person appearance region.

According to this configuration, when determining that the cleaning of the cleaning target area is not completed within the cleaning completion time, controller 110 gives setting unit 109a an instruction to change cleaning strength 610 of the person appearance region in the uncleaned area such that the cleaning is completed within the cleaning completion time. Controller 110 appropriately controls cleaning unit 120 and driver 130 based on changed cleaning strength 610, the current position information about main body 10, and person appearance region information 500. Thus, autonomous travel-type cleaner 100a can efficiently clean the cleaning target area within the cleaning completion time.

In autonomous travel-type cleaner 100a of the first exemplary embodiment, when the cleaning completion time of the cleaning target area is set, setting unit 109a determines whether the cleaning of the cleaning target area is completed within the cleaning completion time based on the information indicating the cleaning completion time. At this point, when determining that the cleaning of the cleaning target area is not completed within the cleaning completion time, the setting unit resets cleaning strength 610 so as to lower cleaning strength 610 of at least one person appearance region. Controller 110 may be configured to control at least one of cleaning unit 120 and driver 130 based on cleaning strength 610 reset by setting unit 109a, the information indicating the current position of main body 10, and the information indicating at least one person appearance region.

According to this configuration, when the user of autonomous travel-type cleaner 100a sets the cleaning completion time, setting unit 109a resets cleaning strength 610 so as to complete the cleaning within the cleaning completion time and so as to lower cleaning strength 610 of the person appearance region. For this reason, controller 110 can appropriately control cleaning unit 120 and driver 130 based on reset cleaning strength 610, the current position information about main body 10, and person appearance region information 500. Thus, autonomous travel-type cleaner 100a can efficiently clean the cleaning target area within the set cleaning completion time.

Furthermore, the first exemplary embodiment is the method for controlling autonomous travel-type cleaner 100a that autonomously travels in the cleaning target area to clean the cleaning target area. Autonomous travel-type cleaner 100a includes cleaning unit 120 that is disposed in main body 10 of autonomous travel-type cleaner 100a to perform at least one of operations of wiping, sweeping, and sucking the dust in the cleaning target area and driver 130 that is disposed in main body 10 to enable main body 10 to travel. In the method for controlling autonomous travel-type cleaner 100a, the information on at least one person appearance region where the appearance rate of the person is higher than the threshold in the cleaning target area is acquired (step S1002), and the current position information about main body 10 is acquired (step S1004). Furthermore, in the method for controlling autonomous travel-type cleaner 100a, cleaning unit 120 and driver 130 are controlled based on the information indicating at least one person appearance region and the information indicating the current position of main body 10 (S1006), and autonomous travel-type cleaner 100a is caused to clean at least one person appearance region in the cleaning target area.

According to this, controller 110 changes the control contents of cleaning unit 120 and the driver 130 such that the person appearance region is different in control from the region other than the person appearance region based on person appearance region information 500 and the current position information about main body 10. Controller 110 appropriately controls cleaning unit 120 and driver 130 based on person appearance region information 500 and the current position information about main body 10. Thus, autonomous travel-type cleaner 100a can be caused to appropriately clean the person appearance region. As a result, autonomous travel-type cleaner 100a can efficiently clean the cleaning target area.

### Second Exemplary Embodiment

Hereinafter, an autonomous travel-type cleaner according to a second exemplary embodiment will be described in terms of items with reference to the drawings.

In autonomous travel-type cleaner 100a of the first exemplary embodiment, the cleaning strength of each person appearance region is set based on the appearance rate of the person. The mode in which the person appearance region in the cleaning target area is cleaned based on the set cleaning strength has been described.

On the other hand, in the autonomous travel-type cleaner of the second exemplary embodiment, first the cleaning strength set based on the appearance rate of the person is reset in consideration of the past cleaning history. The second exemplary embodiment is different from the first exemplary embodiment in that the person appearance region in the cleaning target area is cleaned based on the reset cleaning strength.

For this reason, hereinafter the difference from the first exemplary embodiment will be mainly described, and the common description will be omitted or simplified. That is, because the outline of the autonomous travel-type cleaner of the second exemplary embodiment is basically the same as the outline of the autonomous travel-type cleaner of the first exemplary embodiment, the description is omitted.

[Configuration of Autonomous Travel-Type Cleaner]

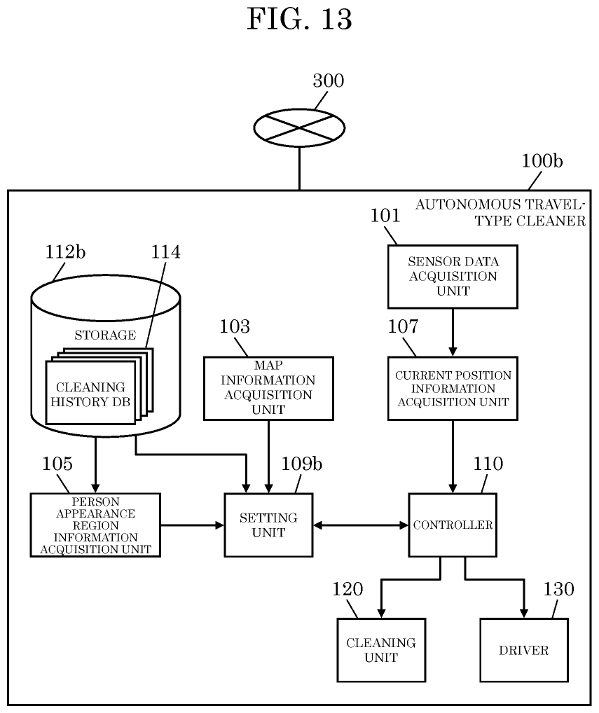

A functional configuration of autonomous travel-type cleaner 100b of the second exemplary embodiment will be described with reference to FIG. 13.

FIG. 13 is a block diagram illustrating a functional configuration of autonomous travel-type cleaner 100b of the second exemplary embodiment.

As illustrated in FIG. 13, autonomous travel-type cleaner 100b is different from autonomous travel-type cleaner 100a of the first exemplary embodiment in that autonomous travel-type cleaner 100b includes cleaning history database (DB) 114. In FIG. 13, cleaning history database 114 is described as the configuration included in storage unit 112b. However, the present disclosure is not limited to FIG. 13. For example, cleaning history database 114 may be disposed on a server (not illustrated) connected to autonomous travel-type cleaner 100b through network 300.

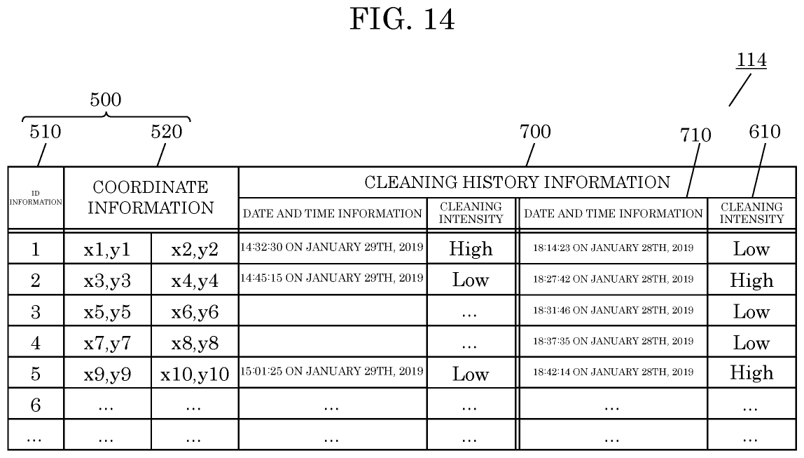

For this reason, cleaning history database 114 will be described first with reference to FIG. 14.

FIG. 14 is a view illustrating an example of a cleaning history database of the second exemplary embodiment.

As illustrated in FIG. 14, cleaning history database 114 is a table in which person appearance region information 500 is associated with information indicating a cleaning history (cleaning history information 700).

For example, cleaning history information 700 includes date and time information 710 indicating a date and time of the cleaning and cleaning strength 610. These pieces of information are associated with person appearance region information 500, and stored in storage 112a.

Date and time information 710 is information indicating the date and time when autonomous travel-type cleaner 100b cleans before this time, and is associated with cleaning strength 610 at that time.

In FIG. 14, coordinate information 520 of autonomous travel-type cleaner 100b is also stored as an example. However, the present disclosure is not limited to FIG. 14. ID information 510 corresponds to ID information 510 about person appearance region information 500 in FIG. 7.

Cleaning history information 700 is information including a cleaning history date and time of the past cleaning by autonomous travel-type cleaner 100b. In the second exemplary embodiment, the configuration including cleaning strength 610 is illustrated as an example. However, the configuration may not particularly include cleaning strength 610. The example in which cleaning strength 610 is divided into two stages of High and Low is indicated similarly to FIG. 8. However, as described in the first exemplary embodiment, the cleaning strength may be divided into five stages of one to five according to the appearance rate of the person.

Cleaning history database 114 is configured as described above.

Hereinafter, the description returns to FIG. 13.

Setting unit 109b in FIG. 13 resets cleaning strength 610 of the person appearance region based on cleaning history database 114. For example, after setting cleaning strength 610 of the person appearance region based on the appearance rate of the person, setting unit 109b resets cleaning strength 610 based on cleaning history information 700 about the person appearance region stored in cleaning history database 114.

In the second exemplary embodiment, an example in which the travel route of autonomous travel-type cleaner 100b is set in advance is described, but the present disclosure is not limited thereto. For example, setting unit 109b may be configured to adjust the travel route in addition to the resetting of cleaning strength 610. For example, when the cleaning completion time is set, setting unit 109b may reset the travel route based on person appearance region information 500, the current position information of main body 10, map information 400, and cleaning history database 114 such that the cleaning is completed within the cleaning completion time.

Controller 110 in FIG. 13 controls at least one of cleaning unit 120 and driver 130 to perform the cleaning based on cleaning strength 610 reset by setting unit 109b, the current position information about main body 10, and person appearance region information 500.

Autonomous travel-type cleaner 100b is configured as described above.

[Operation]

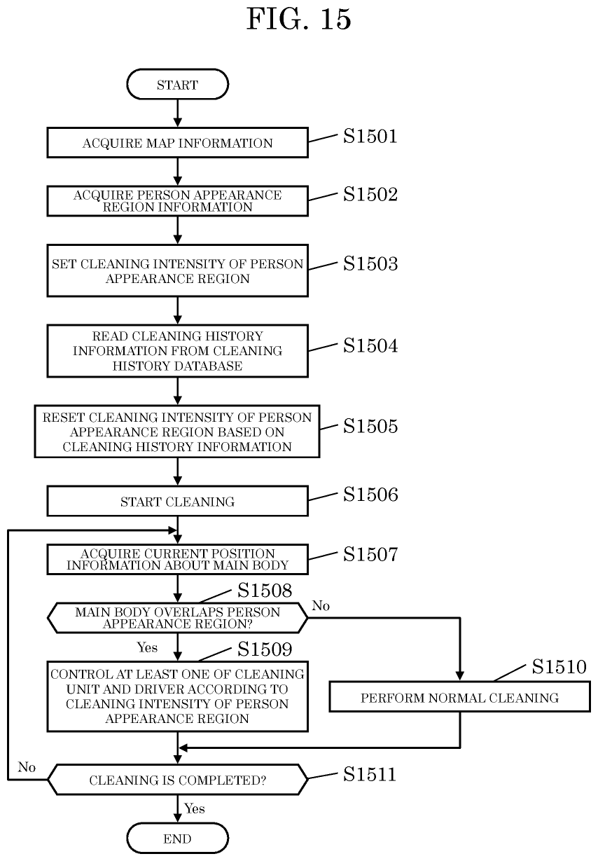

The operation of autonomous travel-type cleaner 100b of the second exemplary embodiment is specifically described below with reference to FIG. 15.

FIG. 15 is a flowchart illustrating an example of the operation of autonomous travel-type cleaner 100b of the second exemplary embodiment. The description of the operation overlapping the operation of the first exemplary embodiment will be omitted or simplified.

In the second exemplary embodiment, it is assumed that the travel route of autonomous travel-type cleaner 100b is previously set similarly to the first exemplary embodiment.

As illustrated in FIG. 15, map information acquisition unit 103 acquires map information 400 (see FIG. 6) indicating the map of the cleaning target area (step S1501).

Subsequently, person appearance region information acquisition unit 105 acquires person appearance region information 500 (see FIG. 7) (step S1502).

Subsequently, setting unit 109b sets cleaning strength 610 (see FIG. 8) of the person appearance region (step S1503).

Subsequently, setting unit 109b reads cleaning history information 700 (see FIG. 14) from cleaning history database 114 in storage unit 112b (step S1504).

Subsequently, setting unit 109b resets cleaning strength 610 of the person appearance region based on read cleaning history information 700 (step S1505). That is, setting unit 109b adjusts cleaning strength 610 of the person appearance region based on cleaning history information 700 in cleaning history database 114. Then, autonomous travel-type cleaner 100b starts the cleaning (step S1506).

At this point, in the person appearance region in which cleaning strength 610 set in step S1503 is Low, the cleaning strength is not reset when the cleaning strength during the previous cleaning is Low. That is, when cleaning strength 610 is not reset, controller 110 controls cleaning unit 120 and driver 130 with the same control content as the control content of the region other than the person appearance region.

Subsequently, current position information acquisition unit 107 acquires the current position information about autonomous travel-type cleaner 100b in the cleaning target area (step S1507).

Subsequently, controller 110 determines whether the position of main body 10 overlaps the person appearance region (step S1508). At this point, when determining that the position of main body 10 overlaps the person appearance region (Yes in S1508), controller 110 controls at least one of cleaning unit 120 and driver 130 based on cleaning strength 610 reset by setting unit 109b, the current position information about main body 10, and the person appearance region information (step S1509). Because the control in step S1509 is similar to, for example, the content in step S1110 (see FIG. 10) in the first exemplary embodiment, the description is omitted.

The reset of cleaning strength 610 will be described more specifically with reference to FIGS. 8 and 14.

Specifically, in the second exemplary embodiment, setting unit 109b reads cleaning history information 700 from cleaning history database 114 with respect to the person appearance region in which cleaning strength 610 set in step S1503 is High. Thus, it is confirmed whether the cleaning strength during the previous cleaning is set to High or Low. When the cleaning strength during the previous cleaning is High, setting unit 109b resets the cleaning strength of the person appearance region to Low. When the cleaning strength in the previous cleaning is Low for the person appearance region in which cleaning strength 610 set in step S1503 is High, setting unit 109b determines that the cleaning strength of the person appearance region is set to High.

On the other hand, for the person appearance region in which cleaning strength 610 set in step S1503 is Low, setting unit 109b reads cleaning history information 700 from cleaning history database 114 to check the cleaning strength during the previous cleaning. When it is confirmed that the cleaning strength during the previous cleaning is not set, setting unit 109b resets the cleaning strength of the person appearance region to Low. That is, when it is confirmed that the same control as the region other than the person appearance region is performed during the previous cleaning, setting unit 109b resets the cleaning strength of the person appearance region to Low. Setting unit 109b does not reset the cleaning strength of the person appearance region when the cleaning strength is Low during the previous cleaning for the person appearance region in which cleaning strength 610 set in step S1503 is Low.

Hereinafter, the description returns to FIG. 15.

Subsequently, when it is determined in step S1508 that main body 10 does not overlap the person appearance region (No in S1508), controller 110 controls autonomous travel-type cleaner 100b to perform the normal cleaning (step S1510). That is, controller 110 performs the cleaning while maintaining the control of cleaning unit 120 and driver 130 in the region other than the person appearance region.

Subsequently, controller 110 determines whether the cleaning of the cleaning target area is completed (step S1511). At this point, when determining that the cleaning of the cleaning target area is not completed (No in step S1511), controller 110 returns to the processing instep S1507, and similarly performs the following steps. On the other hand, when determining that the cleaning of the cleaning target area is completed (Yes in step S1511), controller 110 moves autonomous travel-type cleaner 100b to a predetermined position (not illustrated) such as a charger to finish the cleaning.

When determining that the cleaning of the cleaning target area is completed (Yes in S1511), controller 110 writes date and time information 710 and cleaning strength 610 about the person appearance region in cleaning history database 114 together with the end operation (not illustrated). Specifically, controller 110 adds the time when each person appearance region is cleaned and cleaning strength to cleaning history information 700 of cleaning history database 114. Alternatively, controller 110 overwrites cleaning history information 700 with the time and the cleaning strength. As described above, controller 110 moves autonomous travel-type cleaner 100a to a predetermined position (not illustrate) such as a charger to finish the cleaning.

In the second exemplary embodiment, cleaning strength 610 may be reset similarly to the second example of the operation of autonomous travel-type cleaner 100a according to the first exemplary embodiment. That is, when the user sets the cleaning completion time and when it is determined that the cleaning of the cleaning target area is not completed within the cleaning completion time, setting unit 109b may reset cleaning strength 610 so as to lower cleaning strength 610 of the person appearance region.

In the second exemplary embodiment, cleaning strength 610 may be changed similarly to the third example of the operation of autonomous travel-type cleaner 100a according to the first exemplary embodiment. That is, when determining that the cleaning of the cleaning target area is not completed within the cleaning completion time derived by setting unit 109b, controller 110 may cause setting unit 109b to change cleaning strength 610 with respect to the person appearance region in the uncleaned area of the cleaning target area.

[Effects and Others]

As described above, autonomous travel-type cleaner 100b of the second exemplary embodiment refers to the past cleaning history stored in cleaning history database 114, and adjusts the setting of the cleaning strength of the person appearance region. Consequently, the person appearance region can be cleaned more efficiently than the cleaning according to the cleaning strength set according to the appearance rate of the person.

Specifically, autonomous travel-type cleaner 100b of the second exemplary embodiment further includes cleaning history database 114 in which the information indicating at least one person appearance region is associated with the information indicating the cleaning history including the cleaning date and time of the at least one person appearance region and the cleaning strength. Setting unit 109b resets cleaning strength 610 of at least one person appearance region based on cleaning history database 114. Controller 110 may be configured to control at least one of cleaning unit 120 and driver 130 based on the cleaning strength reset by setting unit 109b, the information indicating the current position of main body 10, and the information indicating at least one person appearance region.

According to this configuration, setting unit 109b resets cleaning strength 610 of the person appearance region set based on the appearance rate of the person in consideration of the cleaning history of the person appearance region. For this reason, controller 110 can appropriately control cleaning unit 120 and driver 130 based on the reset cleaning strength, the current position information about main body 10, and person appearance region information 500. That is, even when cleaning strength 610 set based on the appearance rate of the person in the person appearance region is high, controller 110 refers to the cleaning history, and performs the resetting to lower the cleaning strength when the cleaning is performed every day. Consequently, the cleaning target area can be efficiently cleaned in a shorter time compared with the cleaning with cleaning intensity 610 based on the appearance rate of the person.

### Third Exemplary Embodiment

Hereinafter, an autonomous travel-type cleaner according to a third exemplary embodiment will be described in terms of items with reference to the drawings.

In autonomous travel-type cleaner 100a of the first exemplary embodiment, the travel route is previously decided, and the cleaning strength of each person appearance region is set based on the appearance rate of the person. The mode in which the person appearance region in the cleaning target area is cleaned based on the set cleaning strength has been described.

In autonomous travel-type cleaner 100b of the second exemplary embodiment, the travel route is previously determined, and the cleaning strength set based on the appearance rate of the person is reset in consideration of the past cleaning history. The mode in which the person appearance region of the cleaning target area is cleaned based on the reset cleaning strength has been described.

On the other hand, autonomous travel-type cleaner 100c of the third exemplary embodiment sets the cleaning strength and the travel route of each person appearance region based on the appearance rate of the person. The third exemplary embodiment is different from the first and second exemplary embodiments in that the person appearance region is cleaned in descending order of the cleaning strength.

For this reason, hereinafter differences from the first and second exemplary embodiments will be mainly described, and the common description will be omitted or simplified. That is, because the outline of the autonomous travel-type cleaner of the third exemplary embodiment is basically the same as the outline of the autonomous travel-type cleaner of the first and second exemplary embodiments, the description is omitted.

[Configuration of Autonomous Travel-Type Cleaner]

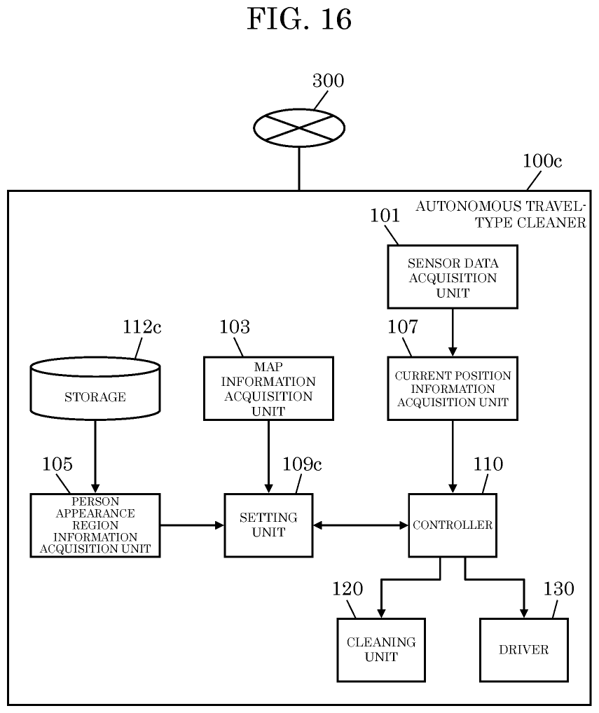

First, a functional configuration of autonomous travel-type cleaner 100c of the third exemplary embodiment will be described with reference to FIGS. 16 to 18.

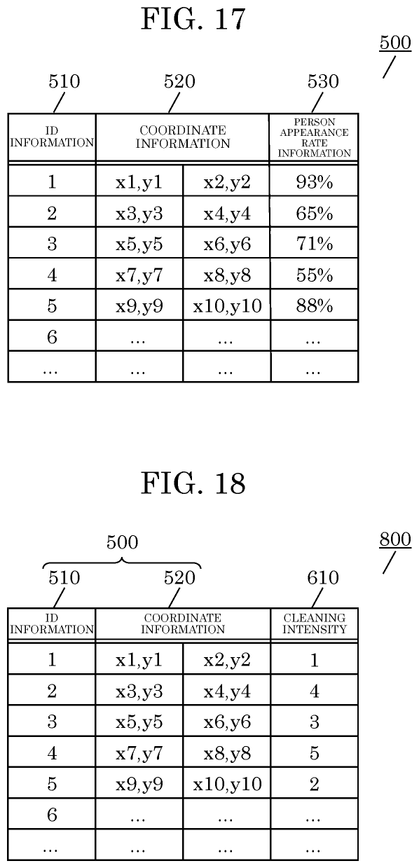

FIG. 16 is a block diagram illustrating the functional configuration of autonomous travel-type cleaner 100c of the third exemplary embodiment. FIG. 17 is a view illustrating an example of person appearance region information 500 of the third exemplary embodiment. FIG. 18 is a view illustrating an example of cleaning strength information 800 of the third exemplary embodiment. At this point, cleaning strength information 800 is a table in which cleaning strength 610, coordinate information 520, and ID information 510 are associated with each other.

As illustrated in FIG. 16, person appearance region information acquisition unit 105 of the third exemplary embodiment acquires person appearance region information 500 stored in storage 112c, and outputs person appearance region information 500 to setting unit 109c. For example, person appearance region information 500 includes information (person appearance rate information 530) indicating the appearance rate of the person in each person appearance region.

At this point, person appearance region information 500 will be described with reference to FIGS. 17 and 18.

When acquiring person appearance region information 500, setting unit 109c sets cleaning strength 610 as indicated by cleaning strength information 800 based on person appearance rate information 530.

As illustrated in FIG. 18, cleaning strength 610 indicated by cleaning strength information 800 is set in five stages of one to five. Because cleaning strength 610 set in five stages has already been described in the description of FIG. 8 of the first exemplary embodiment, the description will be omitted.

As illustrated in FIGS. 17 and 18, cleaning strength 610 is numbered one to five in descending order of the appearance rate of the person in the person appearance region. For example, one is allocated to the cleaning strength of the region where the appearance rate of the person is higher than 90%, and then the numbers of two to five are allocated in ascending order in the descending order of the appearance rate of the person.

As described above, for example, setting unit 109c sets cleaning strength 610 in at least three stages based on person appearance rate information 530 of person appearance region information 500.

Furthermore, setting unit 109c sets the travel route of autonomous travel-type cleaner 100c travelling in the cleaning target area in descending order of the person appearance region of cleaning strength 610. Specifically, setting unit 109c sets the travel route of autonomous travel-type cleaner 100c using the cleaning strength set based on person appearance rate information 530, person appearance region information 500 (ID information 510 and coordinate information 520), the current position information about main body 10, and map information 400. Setting unit 109c stores the set travel route in storage unit 112c as the travel route information.

That is, in the third exemplary embodiment, the travel route of autonomous travel-type cleaner 100c is set such that the person and the appearance region are cleaned in descending order of the cleaning strength. However, the present disclosure is not limited to the third exemplary embodiment. For example, after the cleaning is started, setting unit 109c may change the travel route of autonomous travel-type cleaner 100c according to the instruction of controller 110. Details will be described later.

Controller 110 controls at least one of cleaning unit 120 and driver 130 based on the information indicating the travel route set by setting unit 109c, the current position information about main body 10, and person appearance region information 500. Because the contents of the control have been described above, the description will be omitted.

Autonomous travel-type cleaner 100c is configured as described above.

[Operation]

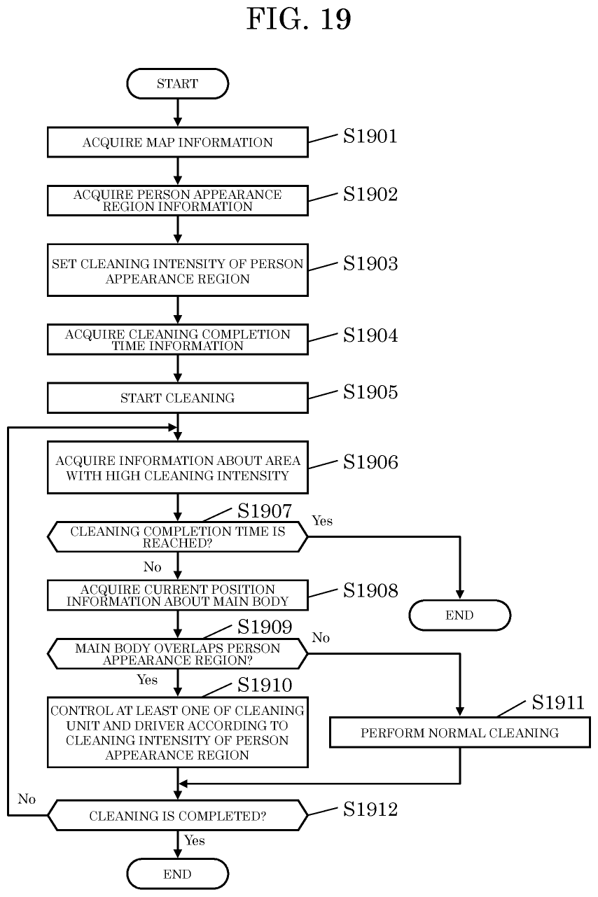

The operation of autonomous travel-type cleaner 100c of the third exemplary embodiment is specifically described below with reference to FIG. 19.

FIG. 19 is a flowchart illustrating an example of the operation of autonomous travel-type cleaner 100c according to the third exemplary embodiment. Hereinafter, the description of the operation overlapping the first and second exemplary embodiments will be omitted or simplified.

As illustrated in FIG. 19, map information acquisition unit 103 acquires map information 400 (see FIG. 6) indicating the map of the cleaning target area (step S1901).

Subsequently, person appearance region information acquisition unit 105 acquires person appearance region information 500 (see FIG. 17) (step S1902).

Subsequently, setting unit 109c sets cleaning strength 610 (see FIG. 18) of the person appearance region using person appearance region information 500 acquired in step S1902 (step S1903). At this point, for example, setting unit 109c may set the travel route of autonomous travel-type cleaner 100c by selecting all the person appearance regions in which cleaning strength 610 is set. For example, setting unit 109c may set the travel route of autonomous travel-type cleaner 100c by selecting the person appearance region greater than or equal to predetermined cleaning strength 610. In this case, setting unit 109c sets the travel route of autonomous travel-type cleaner 100c so as to clean the person appearance region in descending order of cleaning strength 610.

Specifically, when autonomous travel-type cleaner 100c starts the cleaning, controller 110 controls driver 130 to cause autonomous travel-type cleaner 100c to travel toward the person appearance region having high cleaning strength in the selected person appearance regions. Furthermore, autonomous travel-type cleaner 100c performs the cleaning in order from the person appearance region having the higher cleaning strength. At this point, controller 110 acquires information (ID information 510, coordinate information 520, and cleaning strength 610) about the next person appearance region every time the cleaning of one person appearance region is completed. When the position of main body 10 is located in the region other than the person appearance region where the position of main body 10 does not overlap the person appearance region, for example, controller 110 performs the normal cleaning while maintaining the drive strength of the suction motor at a predetermined strength. On the other hand, for example, controller 110 increases the drive strength of the suction motor when the position of main body 10 is located within the person appearance region overlapping the position of main body 10. Controller 110 changes the travel pattern such that autonomous travel-type cleaner 100b reciprocates a plurality of times in the person appearance region, and performs the cleaning according to the cleaning strength.

Subsequently, for example, setting unit 109c acquires cleaning completion time information input by the user (step S1904). The cleaning completion time information may be time information from the start to the completion of the cleaning by autonomous travel-type cleaner 100c, or may be information indicating start time and end time. The cleaning completion time information may previously be set by the user.

Then, controller 110 starts the control of cleaning unit 120 and driver 130. Thus, autonomous travel-type cleaner 100c starts the cleaning (step S1905).

Subsequently, controller 110 acquires information (ID information 510, coordinate information 520, and cleaning strength 610) about the person appearance region where the cleaning strength is high (step S1906).

Subsequently, controller 110 compares the time from the start of cleaning with the cleaning completion time set previously in autonomous travel-type cleaner 100c, and determines whether the current cleaning time is within the cleaning completion time (step S1907). That is, controller 110 determines whether the cleaning completion time is reached. At this point, when controller 110 determines that the cleaning completion time is reached (Yes in S1907), controller 110 controls driver 130 to move autonomous travel-type cleaner 100c to a predetermined position such as a charger, and finishes the cleaning.

On the other hand, when determining that the cleaning completion time is not reached (No in S1907), controller 110 acquires the current position information about main body 10.

Subsequently, controller 110 determines whether the position of main body 10 overlaps the person appearance region (step S1909). At this point, when determining that the position of main body 10 overlaps the person appearance region (Yes in S1909), controller 110 controls at least one of cleaning unit 120 and driver 130 according to the cleaning strength of the person appearance region (step S1910). Specifically, controller 110 increases the drive strength of the suction motor to cause autonomous travel-type cleaner 100c to strongly suck the floor surface. Furthermore, controller 110 may lower the drive strength of driver 130 to decrease the moving speed of main body 10. As a result, the suction rate of the dust on the floor surface is increased. Furthermore, controller 110 may control driver 130 to change the travel pattern of main body 10. For example, as described with reference to FIG. 9, the control is performed such that main body 10 travels in reversals (reciprocates) in a plurality of directions in the person appearance region.

On the other hand, when determining that the position of main body 10 does not overlap the person appearance region (No in step S1909), controller 110 performs the normal cleaning (step S1911). At this point, controller 110 does not control cleaning unit 120 and driver 130 according to the set strength. Specifically, controller 110 may perform the control so as to maintain the drive speed of the suction motor at predetermined strength without performing the control to increase the drive strength of cleaning unit 120. Controller 110 may perform the control such that autonomous travel-type cleaner 100b travels at a predetermined speed by maintaining the drive strength of driver 130 at predetermined strength without performing the control to decrease the drive strength of drive unit.

Subsequently, controller 110 determines whether the cleaning is completed (step S1912). At this point, when determining that the cleaning of the cleaning target area is not completed (No in step S1912), controller 110 returns to step S1906 to acquire the information about the uncleaned person appearance region and the person appearance region with the high cleaning strength in the person appearance regions for which setting unit 109c sets the cleaning strength. Then, the processing of the following flowchart described above is performed. On the other hand, when determining that the cleaning of the cleaning target area is completed (Yes in step S1912), controller 110 controls driver 130 to move autonomous travel-type cleaner 100c to a predetermined position such as a charger, and finishes the cleaning.

In the above description, the example in which after autonomous travel-type cleaner 100c completes the cleaning of one person appearance region, controller 110 acquires the information on the next person appearance region from setting unit 109c has been described. However, the present disclosure is not limited to the example. Controller 110 may monitor the progress of the cleaning and measure the remaining time of the cleaning completion time when autonomous travel-type cleaner 100c cleans the person appearance region, or when autonomous travel-type cleaner 100c travels while cleaning the region other than the person appearance region. At this point, controller 110 causes setting unit 109c to change the travel route and the cleaning strength of the person appearance region of the uncleaned area (referred to as a “cleaning plan”). As a result, setting unit 109c may collate person appearance region information 500 about the person appearance region to be cleaned next and the current position information about main body 10 and the map information to change the cleaning plan. As described above, controller 110 periodically reviews a travel plan of autonomous travel-type cleaner 100c.

[Effects and Others]

As described above, autonomous travel-type cleaner 100c of the third exemplary embodiment cleans the person appearance region in descending order of the cleaning strength. For this reason, for example, the area that is easily dirty can efficiently be cleaned in a limited time.

That is, in autonomous travel-type cleaner 100c of the third exemplary embodiment, setting unit 109c further sets the travel route on which the cleaner travels in the cleaning target area in order from the person appearance region having higher cleaning strength 610 in at least one person appearance region. Controller 110 may be configured to control at least one of cleaning unit 120 and driver 130 based on the information indicating the travel route set by setting unit 109c, the information indicating the current position of main body 10, and the information indicating at least one person appearance region.

According to this configuration, setting unit 109a sets cleaning strength 610 and sets the cleaning route on which the person appearance region is cleaned in descending order of cleaning strength 610. Accordingly, for example, it is possible to preferentially clean the area that is easily dirty and is easily visible to the person in the person appearance region. Therefore, it is possible to preferentially and efficiently clean the area that is easily dirty and is easily visible to the person.

### Other Exemplary Embodiments

Although the autonomous travel-type cleaner and the method for controlling the autonomous travel-type cleaner according to one or more aspects of the present disclosure have been described above based on the exemplary embodiments, the present disclosure is not limited to the exemplary embodiments. Configurations in which various modifications conceived by those skilled in the art are applied to the exemplary embodiment, and configurations established by combining structural elements in different exemplary embodiments may also fall within the scope of one or more aspects, without departing from the scope of the present disclosure.

One aspect of the present disclosure may be a computer program causing a computer to perform each characteristic step included in the method for controlling the autonomous travel-type cleaner. Furthermore, one aspect of the present disclosure may be a non-transitory computer-readable recording medium on which the computer program is recorded.

In the first and second exemplary embodiments, autonomous travel-type cleaners 100a and 100b are controlled to travel along a predetermined travel route. However, the present disclosure is not limited to the first and second exemplary embodiments. For example, the travel route may be set such that the travel route is shortened in consideration of the position of the person appearance region in the cleaning target area. Thus, the travel times of autonomous travel-type cleaners 100a and 100b travelling in the entire cleaning target area can be shortened.

In the first and second exemplary embodiments, when it is determined that the time until the completion of the cleaning (cleaning completion time) is longer than the preset time, the person appearance region may be cleaned in preference to the cleaning other than the person appearance region. That is, for the region other than the person appearance region, the normal cleaning may not be performed, but the cleaning of the person appearance region may be prioritized by passing through the normal cleaning region.

In the second exemplary embodiment, the cleaning strength stored in the cleaning history DB is retained until rewriting. However, the present disclosure is not limited to the second exemplary embodiment. For example, the cleaning strength may be reset when a predetermined certain period elapses. Furthermore, for example, the cleaning history information may be reset while leaving only the last several cleaning histories. Thus, the amount of data can be reduced, and the load on the hardware can be decreased.

In the second exemplary embodiment, cleaning history database 114 stores a set of date and time information 710 and cleaning strength 610 as cleaning history information 700. Furthermore, the example in which setting unit 109b determines whether previous cleaning strength 610 is High or Low to reset cleaning strength 610 has been described. However, the present disclosure is not limited to the example.

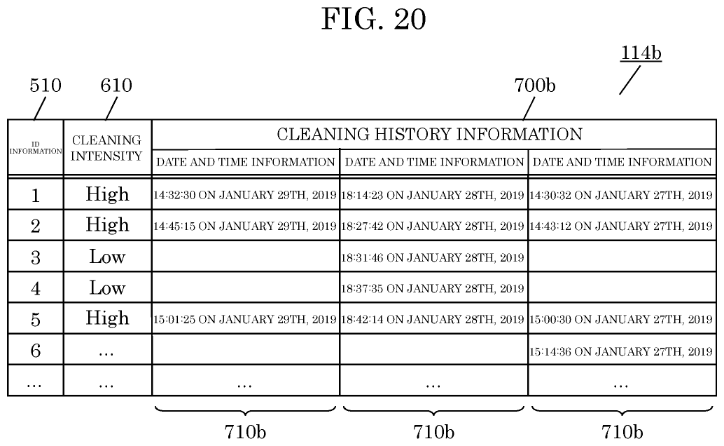

For example, as illustrated in FIG. 20, cleaning strength 610 of cleaning history database 114b may be reset below.

FIG. 20 is a view illustrating an example of cleaning history database 114b according to another exemplary embodiment.

That is, as illustrated in FIG. 20, only date and time information 710b may be stored in cleaning history database 114b as cleaning history information 700b. In this case, for example, when the cleaning strength of the person appearance region is High, setting unit 109b may set a frequency of the cleaning such that the cleaning is performed every time. When the cleaning strength of the person appearance region is Low, for example, setting unit 109b may set the frequency of the cleaning such that the cleaning is performed once every three times.

In the third exemplary embodiment, the configuration in which the cleaning completion time is set has been described as an example. However, the present disclosure is not limited to the third exemplary embodiment, and the cleaning completion time may not be set. In this case, during the cleaning, all the person appearance regions can be cleaned in descending order of the cleaning strength without changing the cleaning plan.

In the third exemplary embodiment, the configuration in which the person appearance region is cleaned in descending order of the cleaning strength has been described as an example. However, the present disclosure is not limited to the third exemplary embodiment. For example, when the cleaner passes through the person appearance region (uncleaned person appearance region) that is not the next cleaning target when moving to the person appearance region to be cleaned, the uncleaned person appearance region overlapping the position of main body 10 may be cleaned by changing the cleaning order.

### INDUSTRIAL APPLICABILITY

The present disclosure can be widely used as the autonomous travel-type cleaner and the method for controlling the autonomous travel-type cleaner capable of efficiently cleaning the cleaning target area such as a commercial facility, a public facility, or a house.

### REFERENCE MARKS IN THE DRAWINGS

10: main body
12: suction port
20: side brush
22: main brush
30: wheel
40: laser range finder
50a, 50b: person appearance region
100a, 100b, 100c: autonomous travel-type cleaner
101: sensor data acquisition unit
103: map information acquisition unit
105: person appearance region information acquisition unit
107: current positional information acquisition unit
109a, 109b, 109c: setting unit
110: controller
112a, 112b, 112c: storage
114, 114b: cleaning history database (cleaning history DB)
120: cleaning unit
130: driver
200: sensor
300: network
400: map information
401: travelable region
402: non-travelable region
403: boundary
500: person appearance region information
510: ID information
520: coordinate information
530: person appearance rate information
600: table
610: cleaning strength
700, 700b: cleaning history information
710, 710b: date and time information
800: cleaning strength information

1. An autonomous travel-type cleaner that autonomously travels in a cleaning target area to clean the cleaning target area, the autonomous travel-type cleaner comprising:
a main body;
a cleaning unit that is disposed in the main body to perform at least one of operations of wiping and sweeping of the cleaning target area and sucking of dust;
a driver that is disposed in the main body to enable the main body to travel;
a person appearance region information acquisition unit that acquires information indicating at least one person appearance region in which an appearance rate of a person is higher than a threshold in the cleaning target area;
a current position information acquisition unit that acquires information indicating a current position of the main body; and
a controller that controls at least one of the cleaning unit and the driver to cause the autonomous travel-type cleaner to clean the at least one person appearance region in the cleaning target area based on the information indicating the at least one person appearance region and the information indicating the current position of the main body.

2. The autonomous travel-type cleaner according to claim 1, further comprises a setting unit that sets cleaning strength that is strength of the cleaning of the at least one person appearance region based on the appearance rate of the person, wherein the controller controls at least one of the cleaning unit and the driver based on the cleaning strength of the at least one person appearance region set by the setting unit, the information indicating the current position of the main body, and the information indicating the at least one person appearance region.

3. The autonomous travel-type cleaner according to claim 2, wherein the cleaning strength is represented by at least one of the drive strength of the cleaning unit, drive strength of the driver, a travel pattern of the main body, a cleaning time, and a cleaning frequency.

4. The autonomous travel-type cleaner according to claim 2, wherein when determining that the main body overlaps any one of the at least one person appearance region, the controller controls at least one of the cleaning unit and the driver according to the cleaning strength of the person appearance region overlapping with the main body.

5. The autonomous travel-type cleaner according to claim 2, wherein when determining that the main body overlaps any one of the at least one person appearance region, the controller controls the driver for causing the main body to reciprocate in the person appearance region, at least between one end of the person appearance region and the other end opposite to the one end.

6. The autonomous travel-type cleaner according to claim 2, further comprising a cleaning history database in which information indicating the at least one person appearance region, a cleaning date and time of the at least one person appearance region, and information indicating a cleaning history including the cleaning strength are associated with one another,
wherein the setting unit resets the cleaning strength of the at least one person appearance region based on the cleaning history database, and
the controller controls at least one of the cleaning unit and the driver based on the cleaning strength reset by the setting unit, the information indicating the current position of the main body, and the information indicating the at least one person appearance region.

7. The autonomous travel-type cleaner according to claim 6, wherein when determining that the main body overlaps the at least one person appearance region, the controller controls at least one of the cleaning unit and the driver according to the reset cleaning strength of the person appearance region overlapping the main body.

8. The autonomous travel-type cleaner according to claim 2, wherein
the setting unit further derives a cleaning completion time completing the cleaning of the cleaning target area, and
the controller further monitors a progress of the cleaning of the cleaning target area, and when determining that the cleaning of the cleaning target area is not completed within the cleaning completion time, the controller causes the setting unit to change the cleaning strength for at least one person appearance region in an uncleaned area of the cleaning target area, and controls at least one of the cleaning unit and the driver based on the changed cleaning strength, the information indicating the current position of the main body, and the information indicating the at least one person appearance region.

9. The autonomous travel-type cleaner according to claim 2, wherein
when a cleaning completion time of the cleaning target area is set, the setting unit determines whether the cleaning of the cleaning target area is completed within the cleaning completion time based on information indicating the cleaning completion time, and when determining that the cleaning of the cleaning target area is not completed within the cleaning completion time, the setting unit resets the cleaning strength by lowering the cleaning strength of the at least one person appearance region, and
the controller controls at least one of the cleaning unit and the driver based on the cleaning strength reset by the setting unit, the information indicating the current position of the main body, and the information indicating the at least one person appearance region.

10. The autonomous travel-type cleaner according to claim 2, wherein
the setting unit further sets a travel route on which the autonomous travel-type cleaner travels in the cleaning target area in order from the person appearance region having the higher cleaning strength in the at least one person appearance region, and
the controller controls at least one of the cleaning unit and the driver based on information indicating the travel route set by the setting unit, the information indicating the current position of the main body, and the information indicating the at least one person appearance region.

11. A method for controlling an autonomous travel-type cleaner that autonomously travels in a cleaning target area to clean the cleaning target area, the autonomous travel-type cleaner including:
a main body;
a cleaning unit that is disposed in the main body to perform at least one of operations of wiping and sweeping of the cleaning target area and sucking of dust; and
a driver that is disposed in the main body to enable the main body to travel, the method comprising:
acquiring information indicating at least one person appearance region in which an appearance rate of a person is higher than a threshold in the cleaning target area;
acquiring information indicating a current position of the main body; and
controlling the cleaning unit and the driver to cause the autonomous travel-type cleaner to clean the at least one person appearance region in the cleaning target area based on the information indicating the at least one person appearance region and the information indicating the current position of the main body.

12. A non-transitory computer-readable storage medium storing a computer program to be executed by a computer for performing the control method according to claim 11.
